(19) United States
(12) Patent Application Publication
(10) Pub. No.: US 2003/0167315 A1
(43) Pub. Date: Sep. 4, 2003

(54) Fast creation of custom internet portals using thin clients

(75) Inventors: Amran Chowdhry, Chicago, IL (US); Matthew Zelinski, Chicago, IL (US); Shawn Carpenter, Chicago, IL (US)

Correspondence Address: Jefferson Perkins, PIPER RUDNICK, P.O. Box 64807, Chicago, IL, 60664-0807, US

(73) Assignee: SOFTWERC TECHNOLOGIES, INC.

(21) Appl. No.: 10/342,092

(22) Filed: Jan. 14, 2003

Related U.S. Application Data
(60) Provisional application No. 60/353,148, filed on Feb. 1, 2002.

(51) Int. Cl. G06F 15/16

(52) U.S. Cl. 709/218

(57) ABSTRACT

Fast creation of custom web portals is permitted by parsing targeted web pages into nested tables, and then selecting which table is to be a portlet in the custom portal. A parser controller and associated JavaScript parser execute all encountered JavaScript statements and replace them with results, making the resultant portlet images easier to parse and manipulate. The provided software produces portlets having several window-like capabilities, including minimizing and maximizing portlets, tiling or superimposing portlets, and dragging and dropping them to any user-selected location on the custom portal page. The user can preselect refresh rates. The portlets can be of pane, link or form varieties. The user also has the option of using portlets whose characteristics are stored in a repository by a network administrator. The software resides on a server and the user/client only needs a browser to employ the invention.

### TECHNICAL FIELD OF THE INVENTION

The present invention relates to the creation of internet or enterprise portals using web-enabled objects or portlets, and more particularly to the custom and automated creation of internally or externally facing web portals.

### BACKGROUND OF THE INVENTION

The browser has become the standard for accessing information available over computer networks such as the world wide web. Generally, a browser resides on the computer of the user and permits the user to connect to and obtain information from any of many network sites. Once a site is selected, the user downloads an image and possibly other information from that site and displays this information on the user's computer. Such information is typically written in a web-enabled markup language such as HTML. The selected web page often contains one or more statements of a second web-enabled language such as JavaScript or Flash. According to the best-known method, in order to visit another site, the user types in the new site's web address or clicks on a link, and exits from the present site entirely to connect to the new site.

As an improvement to this basic methodology, portals have been developed that present, on a single screen, information from several different sites. Some portals are public, while others are created for internal use by employees, customers and/or vendors of a business.

While the use of portals has increased, so has the complexity and cost of creating or developing them. Programming a portal site to standards acceptable to today's users requires significant and long-term effort by entire teams of professionals trained in the IT art. The programming complexity has been greatly aggravated by the use by many sites of two web-enabled languages rather than one alone; this makes their manipulation much more difficult. As using traditional portal programming techniques, portals customized to the needs of small groups or individuals have not been economically feasible.

Recently, software packages have been introduced which permit a user to select modules of information, or “portlets,” from a preexisting library of such portlets for display on a customized portal site. This level of customization is generally not available for public portals or for small corporate groups, and is expensive to implement even for large ones. The portlets selectable by the user are limited to those contained within the software vendor's library and cannot be selected from the web in general. Further, the siting of the portlets are confined to particular regions or columns of the portal page.

### SUMMARY OF THE INVENTION

The present invention provides methods, systems and computer program products for the custom design of web portals by users. A user is able to select any web-enabled object (that is, any object associated with a URL), either now present on the World Wide Web or stored on a database accessible to the user, for use in populating his or her custom portal. The user can select as much as entire web page or any of a plurality of subcomponents therefrom which differ from each other in size and content. A module or portlet is created from this web page or any selected component thereof. This portlet can be stored for later use in a database library. The user can determine where to position this portlet on his or her custom portal, can freely position it at any location within the browser window, can determine how often it needs to be refreshed, can minimize the portlet, can tile the portlet on top of or underneath other portlets, and can delete the portlet. There are no restrictions on siting of the portlet within the portal.

One important aspect of the invention is a parser controller which creates, as its output, easily manipulable images of web pages or components thereof. When the user selects (as by clicking on) an image of a web-enabled object contained within a source web page, the parser controller uses a parser of a first web-enabled language (such as HTML or other mark-up language) to parse the object. When the parser controller determines that a statement in a second web-enabled language (such as JavaScript) exists within the object, the controller invokes a second parser that understands the second web-enabled language. The second parser executes the statement and uses the results of the execution to substitute a statement in the first web-enabled language for the statement in the second web-enabled language. The parser controller thus creates an image or “flat file” (flat only in the sense that statements in the second language are not embedded in the image) that contains only statements in the first language. In this way the first language parser has no difficulty in understanding the object upon which it is operating, and the image is much more easily manipulable (parsing, dragging and dropping, minimizing, maximizing) by the user using Windows-like tools.

In another aspect of the invention, the parser operates on the above-mentioned object image to identify a series of nested components, centered on the location within the source of the page that corresponds to the user's point of selection on the image, and varying in degree of content. The user is presented with a range of choices, from the smallest object or table identified by the parser to the entire web page. The user is then able to choose one of these as the web-enabled module or portlet that will be used in his or her portal. Defining characteristics of the portlet, such as the URL of origin, and the particular component of the web page which is to be retrieved, are stored in a database coupled to the portal creation server. At the start of each session, the defined contents of the portlet are downloaded from the URL and are refreshed thereafter at a predetermined and stored refresh rate.

In yet another aspect of the invention, a user such as a portal administrator identifies a web-enabled object within a source. The parser controller creates a portlet, as before, and stores identifying characteristics of it. The computer then assigns a URL to the portlet. The user uses the URL for the object in retrieving the URL for use in his or her own portal, or in his or her own portal-creating software. Importantly, the portal-creating software (such as Plumtree®) can be licensed from a third party and need only understand a URL-identified object to use any of the stored portlets.

A principal technical advantage of the invention is that it permits the building of custom portal components in a limited amount of time, by end users who do not need to be proficient in markup languages. The large expenditure of time and money associated with traditional portal creation techniques are avoided. These savings in cost and time bring custom portal creation within the reach of individual and relatively small groups.

Other aspects of this invention provide for rapid integration of portlets into third-party portal products and separately provide unique capabilities for the creation of the portal user interface that gives users windows-like functionality.

In total, this invention significantly reduces the time for developing portals by automating the aggregation of data to be represented to the user. This time reduction changes the way portals are used as well—as now they can be used as real time tools to track the management of a business, because the interfaces to the business can be modified at pace with the rate of change in the business.

Additionally, people with less technical knowledge can set up portals because provides a point-and-click interface for data collection and portlet creation.

The invention further provides the possibility for increased integration. Often various parts of a company create separate portals. The present invention allows these portals to be quickly integrated into a single ‘super-portal’ across the whole company.

### BRIEF DESCRIPTION OF THE DRAWINGS

Further aspects of the invention and their advantages may be discerned from a review of the following Detailed Description when read in conjunction with the drawings, in which like characters identify like parts and in which:

FIG. 1 is a schematic system diagram showing a network environment in which the invention may be employed;

FIG. 2 is a diagram of a web portal constructed according to the prior art;

FIG. 3 is a screen of a web portal constructed according to the invention;

FIG. 4 is a high level schematic diagram of a custom portal creation software architecture according to the invention;

FIG. 6 is a diagram illustrating a software architecture of one embodiment of the invention;

FIG. 8 is a screen diagram of a user interface illustrating a step in the operation of an Add Portlet programming module;

FIG. 9 is a use case diagram illustrating the different actions which a registered user can take in respect of an individual portlet;

FIG. 10 is a flow diagram showing different possibilities in the creation of a portlet;

FIG. 11 is a sequence diagram illustrating the operation of the Add Portlet programming module;

FIG. 12 is a screen diagram illustrating a next step in the operation of an Add Portlet programming module where it is desired to retrieve a portlet from the Web;

FIG. 12A is a screen diagram showing a prompt for entry of a title and refresh time for a new portlet;

FIG. 13 is a high-level flow chart showing operation of a markup parser according to the invention;

FIG. 14 is a high-level flow chart showing operation of a script parser according to the invention;

FIG. 15 is a diagram of a screen associated with a step in the operation of the Add Portlet programming module;

FIG. 16 is a screen diagram illustrating a further step in an Add Pane sequence;

FIG. 17 is a sequence diagram showing an add pane sequence;

FIG. 18 is an add pane sequence diagram showing events where data from a given URL could not be retrieved;

FIG. 19 is a screen diagram showing a step in a Customize Pane sequence, in which rows of the pane can be selected for inclusion;

FIG. 20 is a screen diagram showing a beginning step in an Add Form sequence;

FIG. 21 is a sequence diagram showing operation of the Add Portlet programming module when a form is selected as the portlet to be retrieved;

FIG. 22 is a sequence diagram showing an Add Form sequence in which the data from the given URL could not be retrieved;

FIG. 23 is a sequence diagram showing an Add Form sequence in the instance that the URL specified by the user contains no form;

FIG. 24 is a screen diagram showing a step in an Add Form sequence;

FIG. 25 is a screen diagram showing the results of an add form sequence;

FIG. 26 is a screen diagram showing a beginning step in an Add Links sequence;

FIG. 27 is a sequence diagram showing the operation of the Add Portlet module and related components in an Add Links sequence;

FIG. 28 is a sequence diagram showing an Add Links sequence in which data from the specified URL could not be retrieved;

FIG. 29 is a sequence diagram showing an Add Links sequence in which the URL specified by the user contains no links;

FIG. 30 is a screen diagram showing a step in the Add Links sequence;

FIG. 31 is a screen diagram showing a step in the Add Links sequence;

FIG. 32 is a sequence diagram illustrating the operation of a Refresh Portlet programming module of the invention;

FIG. 33 is a sequence diagram illustrating the operation of the Refresh Portlet programming module in the instance that data from the indicated URL could not be retrieved;

FIG. 34 is a sequence diagram illustrating the operation of a Delete Portlet programming module of the invention;

FIG. 35 is a screen diagram showing a warning prior to executing a portlet deletion;

FIG. 36 is a use case diagram showing choices a user can make in respect of portal pages created according to the invention;

FIG. 37 is a diagram of a user interface screen on which a user can design a portal;

FIG. 38 is a sequence diagram illustrating the use of a View Page programming module, where a page is being viewed during the first time in a session;

FIG. 40 is a sequence diagram illustrating the use of a View Page programming module provided according to the invention;

FIG. 41 is a sequence diagram illustrating the operation of the Rearrange Portlets programming module;

FIG. 42 is a sequence diagram illustrating the operation of the Rearrange Portlets programming module in the instance that the registered user cancels a Rearrange Portlets operation;

FIG. 43 is a diagram of a screen showing the results of a Rearrange Portlets operation;

FIG. 44 is a screen illustrating a step in the Rearrange Portlets process;

FIG. 45 is a screen diagram showing a directory listing of a portlet repository;

FIG. 46 is a sequence diagram showing retrieval of a default portal page upon log in;

FIG. 47 is a sequence diagram illustrating the use of an Add Page programming module;

FIG. 48 is a diagram of a screen prompting for a title of a new page;

FIG. 49 is a sequence diagram illustrating the operation of the Rename Page programming module;

FIG. 50 is a diagram of a screen showing use of a Rename Page programming module of the invention;

FIG. 51 is a sequence diagram illustrating the operation of a Delete Page programming module according to the invention;

FIG. 52 is a sequence diagram illustrating the operation of the Delete Page module in the instance that the page sought to be deleted is the user's default page but the user has at least one other page;

FIG. 53 is a sequence diagram illustrating the operation of the Delete Page programming module in the instance that the page sought to be deleted is the user's default page and the user has only one page in his or her profile;

FIG. 54 is a sequence diagram illustrating the operation of the Minimize Portlet programming module;

FIG. 55 is a sequence diagram illustrating the operation of the Maximize or Restore Portlet programming module;

FIG. 56 is a diagram of a screen showing a step in the operation of a Minimize Portlet programming module;

FIG. 57 is a diagram of a screen illustrating a step in the operation of a Maximize or Restore Portlet programming module;

FIG. 58 is a sequence diagram illustrating the operation of a Rename Portlet programming module of the invention;

FIG. 59 is a diagram of a screen used in Editing/Renaming a preexisting portlet;

FIG. 60 is a sequence diagram showing steps in manually refreshing a portlet; and

FIG. 61 is a sequence diagram for manually refreshing a portlet where data from the indicated URL could not be retrieved.

(Descriptions for FIGS. 5, 7 and 39 are intentionally missing. These FIGURES do not exist, have not been provided with the application as filed and form no critical part of the disclosure of the invention, nor are they necessary for any purpose under 35 U.S.C. §112.)

### DETAILED DESCRIPTION OF ILLUSTRATED EMBODIMENT

### Overview

A system according to a preferred embodiment of the invention is made up of several components. When implemented, these components can be strung together in a way that makes the system scalable and redundant.

The components are:

Parsing engine. The parsing engine is responsible for three main functions. It collects data on behalf of the user and parses it in such a way that the user has a great amount of control when building portlets from it. The parsing engine also is responsible for the unique presentation of display options from which users can choose exactly the portion of the page they want included in their portlets. (The inventors have adopted the mark WERCLETS™ for the portlets created by this system and the system so creating it.) Finally, the parsing engine is responsible for storing the portlets and all the information that defines the portlets in a database.

The parsing engine is responsible for intelligently breaking down the source web pages and categorizing the entire page, so that it can be presented to the user for selection. After selecting a component of the page, the parsing engine presents the user with various options for displaying the component along with other pieces of the source page as a portlet. The parsing engine is also responsible for storing information pertaining to the portlet in local databases.

A principal technical distinction over the prior art is the way in which the invention breaks down the source page, categorizes the components, and provides user presentation options—all on the fly without the user having to do anything different than he or she would in a normal browser.

Caching engine. The caching engine is responsible for ensuring the timeliness of portlet data by monitoring a refresh interval. As the refresh interval expires, the caching engine requests that the parsing engine retrieve updated data, which is then stored in the caching engine for users accessing the portlets.

The caching engine is responsible for managing how often portlets need to be updated and asking the parsing engine to retrieve them when their time is due. The cache engine stores the updated portlet information so that users can always have the latest data available with very fast response times.

Portlet Wizard. The portlet wizard is the user interface for creating portlets. It interfaces with the parsing engine so that users can access the parsing and content aggregation features of the system. It also collects data about the portlets being created from the user, such as expiration date and refresh interval, and then passes it to the parsing engine which stores the portlet in a database.

The portlet wizard is the user interface for creating portlets. The portlet wizard can be activated from a number of different points in the product.

URL Generator. The URL Generator is an aspect of the parsing engine that provides a URL as a reference to each portlet. This URL makes it simpler than ever before to access portlets from any third-party portal product on the market.

The URL Generator is a passive interface. Using the portlet wizard to create portlets can cause the system to create a URL so that the portlet can be accessed from any standard internet browser. This features is key to providing the ease of integration between our invention and portal management products on the market, such as SunONE®0 Portal Server or BEA WebLogic® Portal Server.

Portlet Manipulation User Interface. This is a portal interface itself (called a WERCSPACE™ by the inventors) which users and administrators can use to create personalized portals that have much of the functionality that a WINDOWS® desktop has, as opposed to a typical portal which behaves more like a page of print than a computer interface. Users can collect information and application portlets within their user interface and have great freedom as to the placing of these portlets within their portal pages. The user interface permits retrieval of portlets from a repository that can be pre-built for users, and from which users can drag-and-drop portlets into the portal pages they are building.

The parsing and caching engines are services that the invention provides. These services are accessed through various user interfaces, defined by the latter three components introduced above.

The user interface is the aspect of the invention that provides users with an internet portal having windows-like functionality. Functionality available in the user interface has only before been available to users of non-browser based applications.

The invention enables data to be displayed in many different, independently operating windows, yet to be managed as a single display.

These various components can be used in total as a system or piecemeal by using either the system with the URL Generator or with the user interface. When used with only the URL Generator, users are required to use a third-party portal server and this invention will be used as a data/content aggregator and consolidator only. Users receive the benefit of rapid content aggregation using the invention's graphical portlet wizard to create portlets. When used with the user interface, the system is used to provide both content aggregation as well as a portal presentation interface where users can add, delete and rearrange content modules, as defined below, to their suit their own personal needs with much more flexibility than previously available.

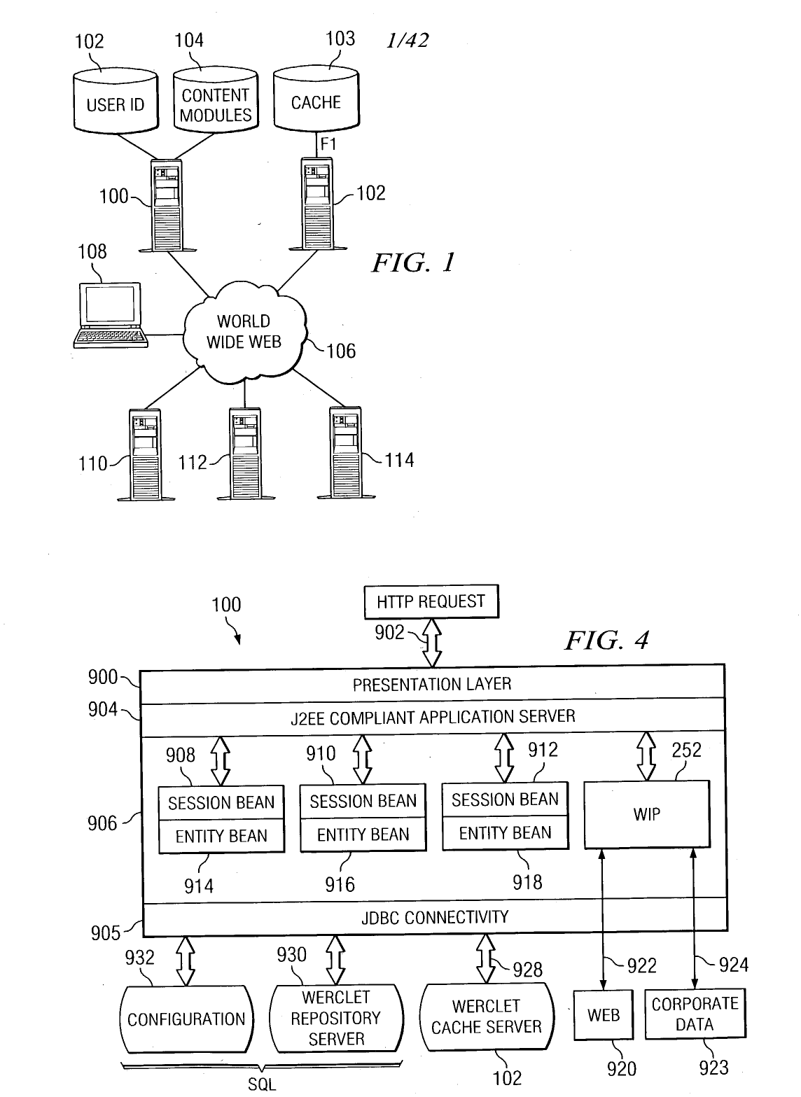

Repository. The repository is a database (FIG. 1, 103) of portlets that can be accessed from the user interface or from the user interface's administrative interface. Portlets are stored in the Repository 103 in such a way that portlets can be re-used by users by dragging them from the Repository into the user interface pages.

### Architecture

Environment

Referring to FIG. 1, a web portal content creation application host server 100 (programmed to include the parsing engine) has connected to it a database 104 that stores user information and portlet parameters.

The user information stored by database 104 includes login and password information as well as parameters necessary to determine data access rights and privileges.

Database 104 also stores all parameters necessary for recreating portlets that have been defined by the portlet authors. Portlet authors may create portlets using the portlet wizard and store them in this database for either personal or shared use.

Portlets stored for shared use are referred to as being stored in the Repository. Users can open the repository and select portlets for their portal if they have the appropriate rights as assigned by an administrator and stored in the database 104.

Another server acts as a caching server 102 and has attached to it a cache 103. The cache 103 stores the actual portlet contents as defined in database 104. The caching server 102 updates the actual portlet contents based upon a parameter called the “refresh interval”. This parameter is assigned by the creator of the portlet during the creation procedure.

The parsing engine 100 and cache server 102 are connected to a network, which is in this illustrated embodiment the Internet 106. Network 106 could otherwise be a wide area network (WAN) of another kind or a local area network. Also connected to the network 106 is a thin client user computer 108 (only a representative one is shown), which only requires an operating system and internet browser, and a plurality of web-enabled content host servers 110-114, the illustrated three being representative of the millions of possible sources for web-enabled content that are accessible through the Internet 106 or private networks (not shown).

Host servers 110-114 each provide information in web-enabled form typically using a markup language (such as HTML, XML, or others), one or more scripting languages (JavaScript, Perl, VBScript, or others), and self-contained application objects (such as ActiveX or Flash). This information, organized into pages, is displayed in a browser on a user's computer 108. Each page of information obtained in this manner and displayed on a user's computer 108 is generally termed a web page. A plurality of web pages which are connected and which generally pertain to the same information are generally termed a web site.

Portals comprise web pages which include a plurality of modules or portlets. Each module or portlet comprises content that can be received from a different web site source. A portal provides users with the flexibility to personalize the look and feel of the pages they view as well as the specific content presented in their pages.

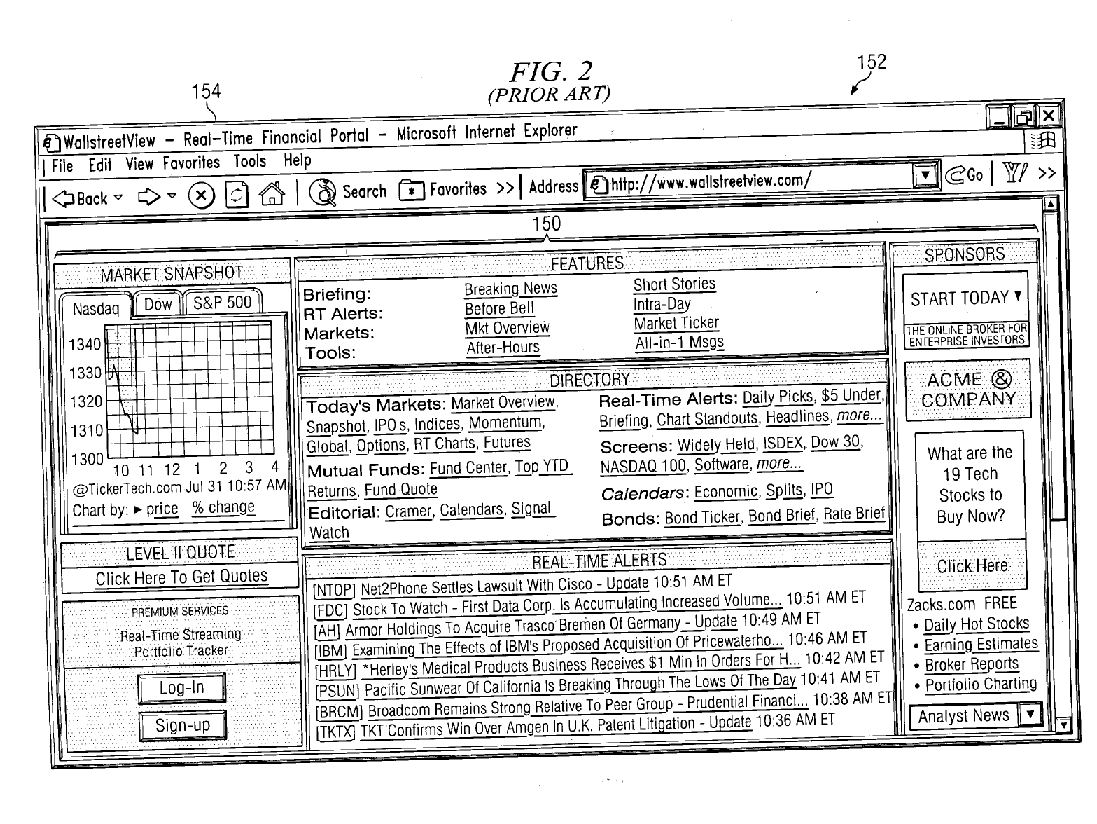

One example of a conventional portal is shown in FIG. 2 with a plurality of modules 150 positioned on a web page 152 shown in browser window 154. Various aspects of our invention enable each content module or portlet to be created more quickly. The resulting portal would look exactly the same as that shown in FIG. 2, but the amount of effort required to create it will have been significantly reduced.

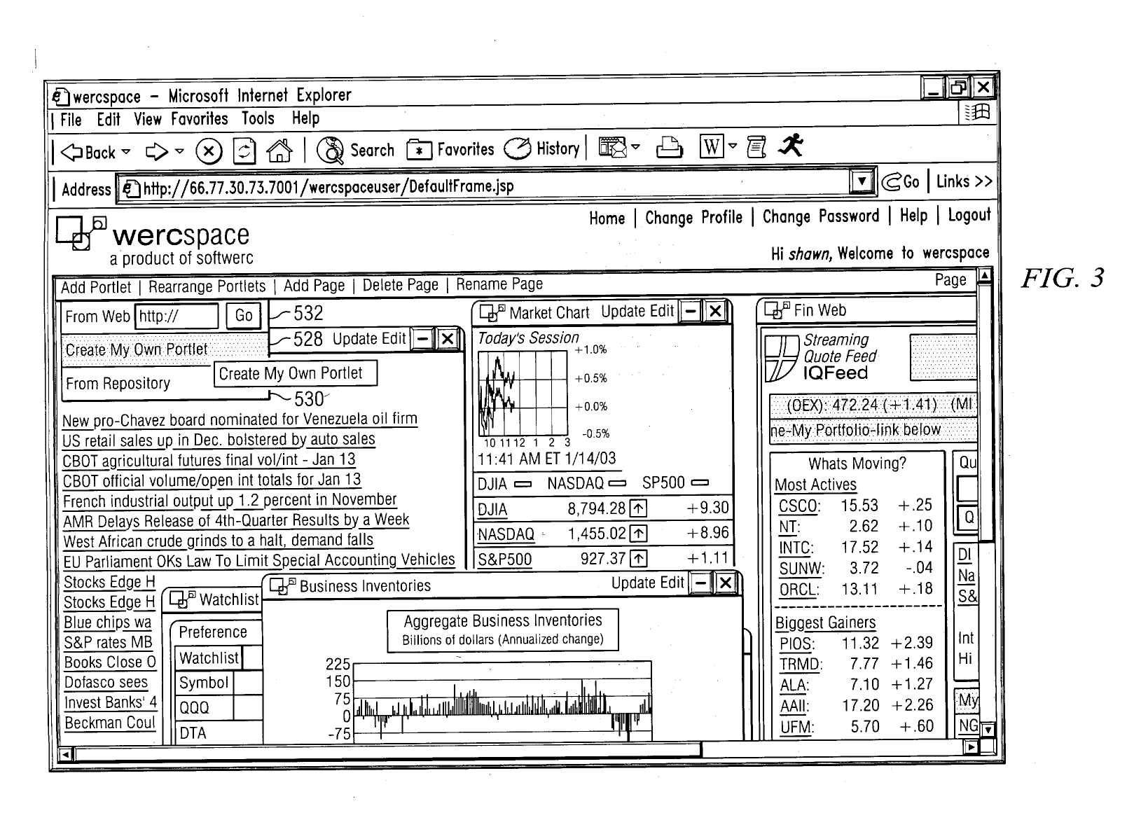

FIG. 3 illustrates a portal created according to the invention. Users are provided with more control over the content displayed in a portlet or module and the location of the modules within the page. Specifically, our invention allows modules to be created by the end user (see buttons 528 and 532), rather than only ahead of time by administrators (see button 530); it allows all modules be placed freely anywhere in the web page by the end user and to be layered to optimize the use of page ‘real-estate’; and allows the portlets or modules to be independently refreshed (updated) based upon initial module configuration.

Data Flow

The portlet database 104 includes a parameter for refreshing the contents of a portlet. When a portlet is first created, the parsing engine 100 retrieves the actual portlet content and passes it, along with the refresh interval parameter, to the caching server 102. The caching server 102 stores the actual portlet content in the cache 103 and monitors the refresh interval.

The reason that the actual portlet content is stored by the caching server in the cache 103 is to improve the performance of the system by keeping portlet content close to the user. The responsibility for keeping content fresh is offloaded from the parsing engine 100 to improve the scalability of the system. The parsing engine 100 can focus on parsing web pages, creating portlets, and presenting them to users in the user interface, while the caching server 102 can focus on making sure data for the numerous portlets is kept up to date based upon the refresh interval set by the portlet author.

At a user level, a typical user of the present invention can design and implement a portal customized to his or her requirements and only with knowledge of the general operation of a browser, and without skills associated with browser, ASP, HTML, JavaScript or other programming knowledge.

### Architecture

FIG. 4 is a diagram of a software architecture according to the invention. A presentation layer 900 is made up of any of several browsers known in the art and handles the communication link 902 to each of the clients through http requests. A server 100 according to the invention also requires a J2EE compliant application server software layer 904. The “portlets” software 906 sets up copies of itself as session beans 908-912, three shown here for purposes of illustration. These in turn are communicating with respective entity beans 914-918, which represent interactions with various user clients. The portlet software application also includes the parsing engine, which includes the parser controller 252 and related modules. The parser controller 252 interfaces with web locations 920 through communications link 922, and may further link to internal corporate data 923 through link 924.

The portlet cache server 102 communicates to the portlet software 906 through a JDBC connection layer 928. The cache server 102 stores the contents of those portlets which have been requested by users that are currently on-line. Each time any of the retrieved portlets is refreshed, the refreshed contents are stored in the portlet cache server 102; the cached information for a portlet persists only for so long as there is at least one user session bean 908-912 open which uses that portlet.

A portlet or “WERCLET” repository server 930 (same as database server 102) stores all necessary identifying characteristics of each portlet which the administrator has attached to tree 750 (see FIG. 45). A configuration server 932, which physically can be server 102 or a separate server, stores characteristics of each of the custom portal pages which has been authored and which is still being used by any one of the users.

### Invention From a Systems Perspective

Overall Architecture

The present invention permits the creation of portlets, which are modules of an internet portal. The inventors have adopted the mark WERCLETS™ to identify portlets created by the system of the invention. Once created, portlets can be put together into a web page using third party portal software by creating a portlet and then generating a URL to access it through the invention, or portlets can be stored in a repository for users of the user interface to create their own portal.

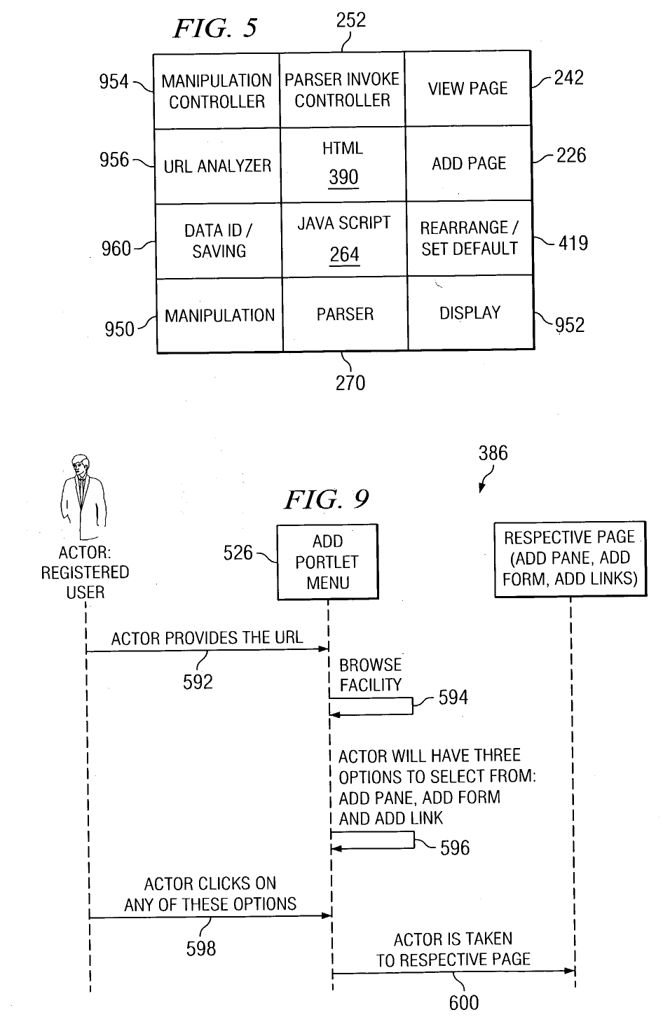

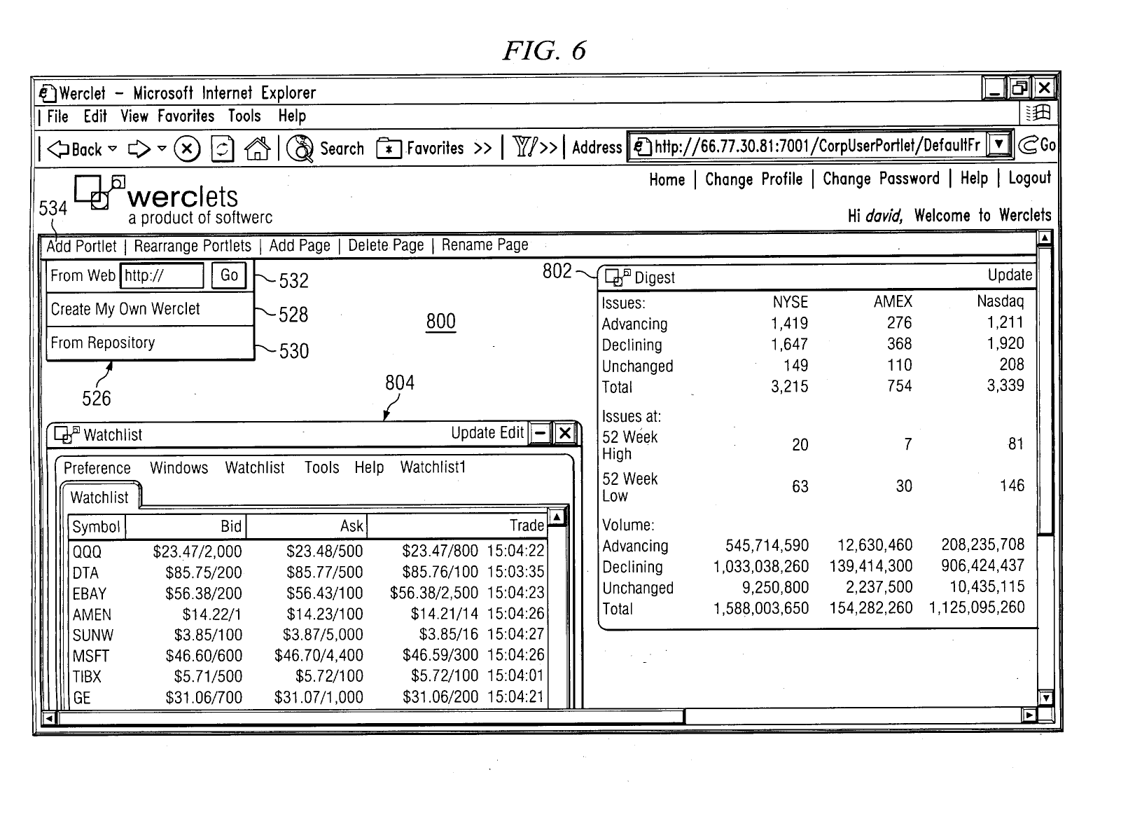

FIG. 6 shows three groups of software modules of the system. Two of these, grouped under the headings Manipulation 950 and Parsing 270, are responsible for the creation of a portlet. The third group, the Display group 952 in FIG. 6, is responsible for the user interface display. A view page module 242 is responsible for managing the interface to the user. As the user selects options within the interface to initiate actions, such as adding a page or rearranging a page, one or the other of these modules (226, 419 respectively) are called, perform their functions, and return to the view page module 242 for control of the user experience.

The manipulation group 950 maintains responsibility for all data manipulation regarding creating and saving werclets. It includes a URL analyzer 956, a module that analyzes HTML to see if it can be parsed, a manipulation controller 954, which is a module that manipulates the data prior to parsing so that it can be used by the portlet wizard to create a portlet, and a data identification and saving component 960, which after a portlet has been created is responsible for gathering all the data that represents the portlet, saving it and making sure the cache server 102 has the portlet stored according to the parameters specified during portlet creation.

The parser group 270 maintains responsibility for all the intelligence behind the creation of the portlets and includes a parser controller 252, which is intelligence used to determine which parser to employ. To parse other markup or scripting languages is a matter of creating a parser with a library for defining what commands to change and the syntax for changing them, so that the source script can be run from the system 100 and successfully incorporated into a portlet. In this illustrated embodiment, the parser group includes an HTML parser 390 and a JavaScript parser 264.

### Definitions

Portlet Wizard: User interface to the portlet creation engine that enables users to graphically (e.g., using a mouse to implement most functions) create portlets.

Browse Facility: This is a first pass at parsing performed by the portlet wizard, modify markup script so that it can be browsed while staying within the system. At the same time, the browse facility verifies markup and scripting code to ensure that it is parsable. If not, it makes modifications to try to make it parsable.

### Parsing and Creating Portlets

Creating portlets is a two step process: first the data source is identified, and then the appropriate presentation format is selected.

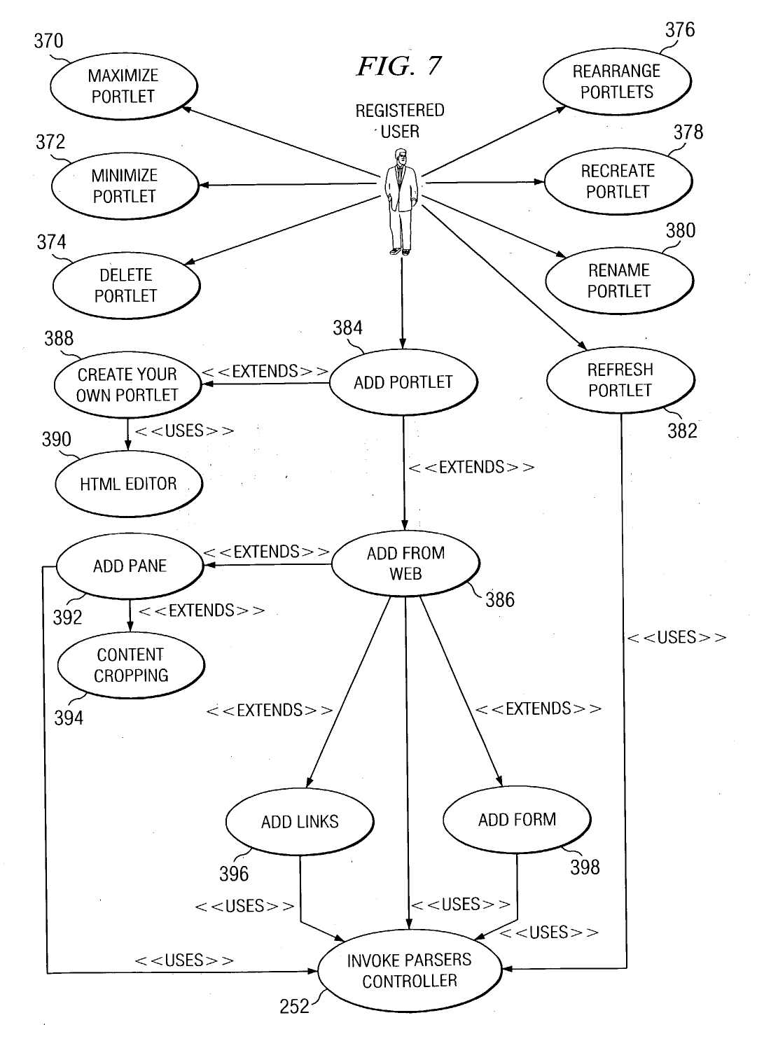

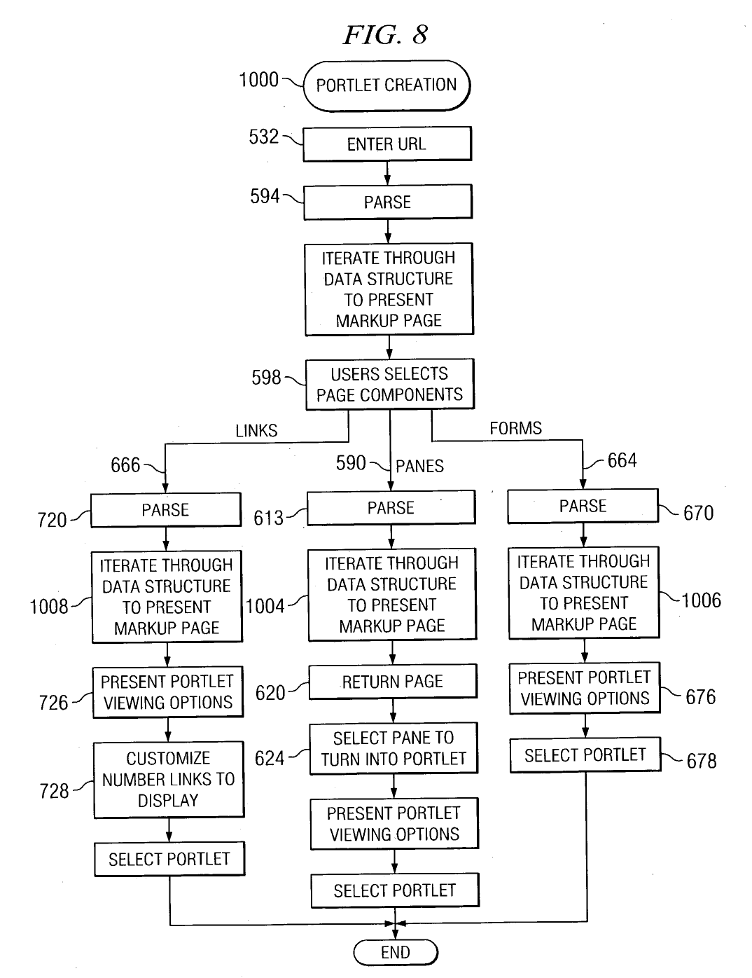

FIG. 8 shows a user portlet manipulation page 800 or space (the inventors have adopted the mark WERCSPACE™ to identify it). Page 800 is shown in a condition at the beginning of the illustrated embodiments for starting the process of adding portlets to the system. Two portlets 802, 804 are already present on page 800, and a dropdown list 526 has appeared after the user checked on an “add portlet” button 534. In this embodiment, a user is presented with two choices when creating a portlet: to create from the web (532) or to write their own (528). (A third choice shown in this FIGURE, ‘From Repository’ 530, is not for creating portlets, but rather for reusing already created and stored portlets. This choice will be described later.)

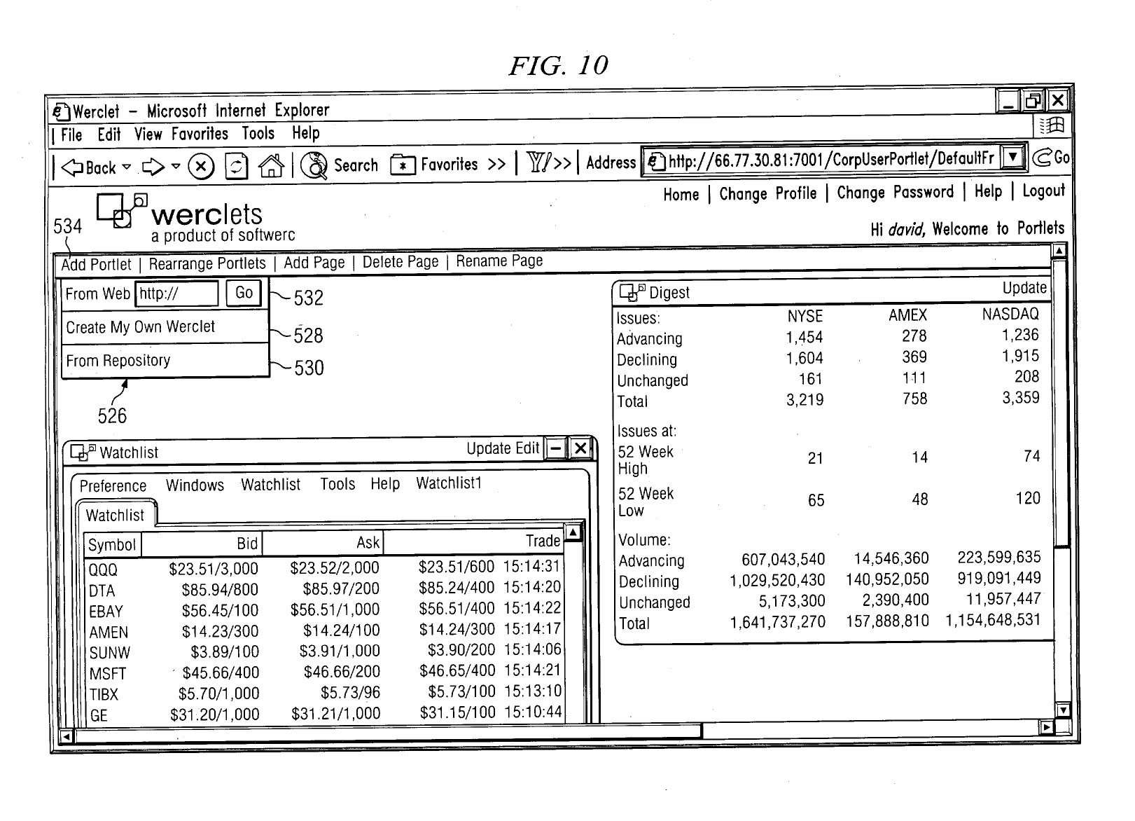

FIG. 9 is a formal UML representation or use case diagram for, inter alia, creating a portlet. The point at which the registered user decides to add a portlet is indicated at 384. A user creating a portlet from the web (step 386) would use the portlet wizard to create portlets armed only with the knowledge of the general operation of a browser, and with skills associated with browsers. The portlet wizard is accessible by any system with a browser from the application host 100 in FIG. 1. This use case is also represented at the beginning 1000 by the data flow diagram in FIG. 10.

Continuing with the FIG. 9 use case diagram, upon choosing to add a portlet 384, users are presented with two choices, adding a portlet from the web 386 or creating their own portlet at 388. When creating their own portlet 388, users do not take advantage of the parsing capabilities of the invention, but rather write custom web components using HTML, JavaScript, or other language, which is then passed off to data identification and saving module 960 in FIG. 6, which saves the parameters in the database 104 and the content in the cache 103 for access either from third party products via the URL generator or from the user interface through the Repository 104. When creating and manipulating their own portlets at 388, although the parser isn't used to create the portlet, users retain all the WINDOWS®-like functionality of the user interface that makes it different from prior-art portal presentation products.

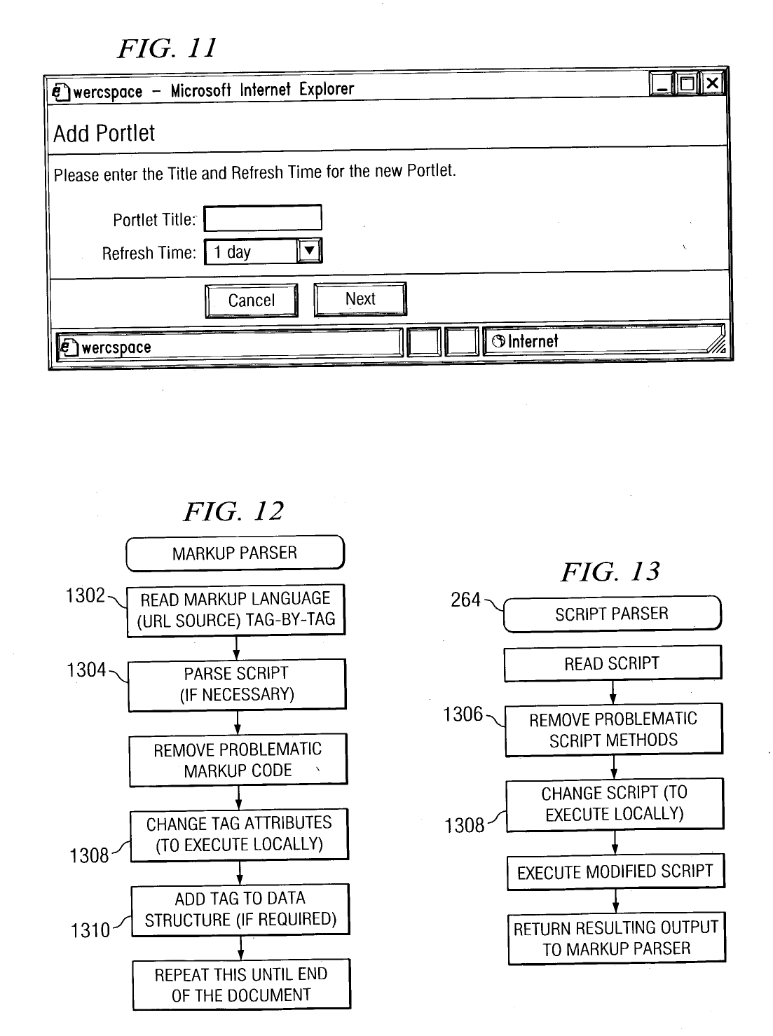

When adding a portlet from the web at 386, users launch the portlet wizard by entering a URL (532 in FIGS. 10 and 12). In the illustrated embodiment, the system collects specific portlet parameters, such as name, expiration date, and refresh interval from users at this point. Following this, FIG. 10 shows the flow of operations as well as the range of choices which occur in the creation of a portlet. FIGS. 11, 17, 18, 21, 23, 27, 28 and 29 provide the UML compliant sequence diagrams to provide a technical definition of this data flow.

FIG. 11 shows the sequence diagram for the first phase of creating a portlet.

When a URL is first entered at step 592 (see also the user interface screen shown in FIG. 12), the portlet wizard is launched as the user interface for creating the portlet (FIG. 12A). The URL entered by the user at 592 is passed to the parser for a first parsing 594. This first parsing is known as the browse facility (“parse” 594 in FIG. 10) because it enables the page to be browsed within the portlet creation utility. When a page is parsed by the browse facility, each HTML tag is read (step 1302, FIG. 13) and categorized into a data structure (step 1310) so that the system can understand how the page is built and the anchor tags are re-written (see step 1308, FIG. 13) so that the links are fully qualified. This is important because the pages will be executed from server 100, and if the links aren't fully qualified, they will point to links non-existent on server 100. By fully qualifying them, they point to the original source, so when a user clicks on them, they work properly. This is described in more detail below. Once parsed, the user is presented with the page, which to all external appearances looks and behaves just like the original page, and given options at step 596 (FIG. 11) for what part of the page to turn into a portlet. The selection at 598 by the user determines the next steps taken (path 600) by the parser controller 252.

The browse facility parse is not stored permanently. Once a user proceeds to the next step, this information is thrown away and a second parse is completed.

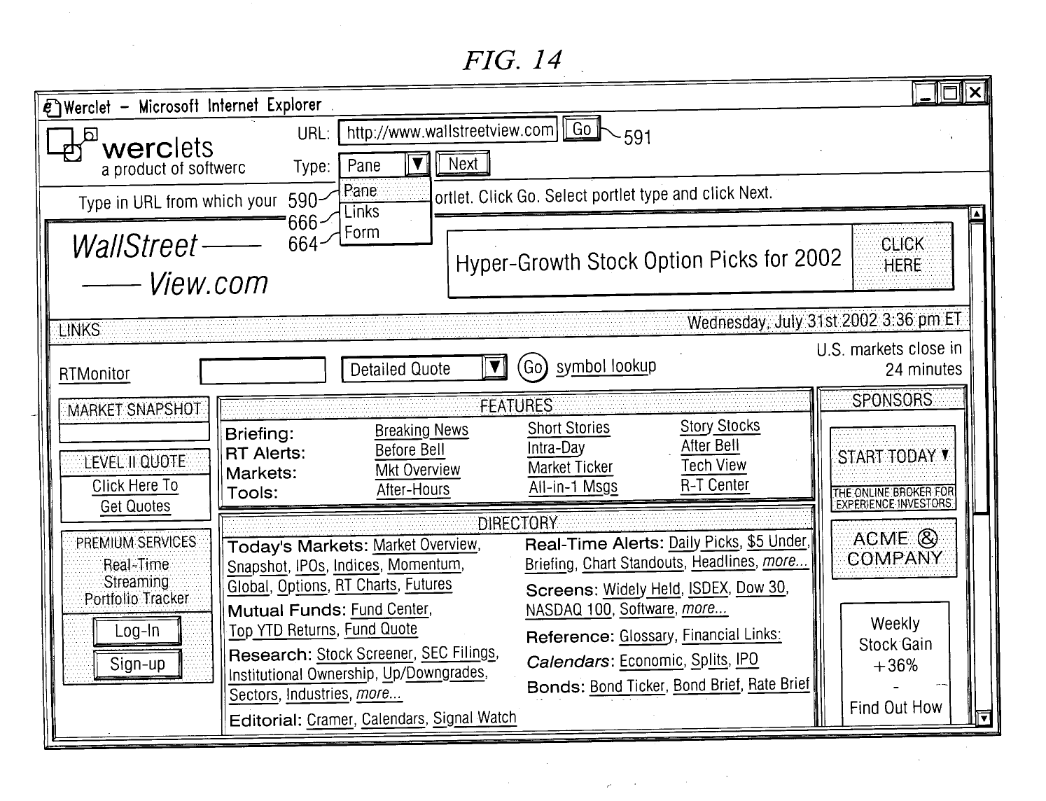

The browse facility parse has a workflow described in FIGS. 13 and 14. FIG. 13 shows the flow for the markup parser, while FIG. 14 shows the flow for the scripting parser.

First the parsing engine reads (step 1302 in FIG. 13) each character of the HTML file. As it encounters a tag, it classifies it according to one of four types and saves it sequentially (step 1310 in FIG. 13), along with the tag's attributes, into a data structure. All HTML tags according to the HTML specification are stored.

The data structure is stored as follows:

| Index | Value |
|---|---|
| 1 | Structure Row |
| 2 | Structure Row |
| 3 | Structure Row |
| — | — |
| — | — |

Each object within the structure row has the following characteristics captured with it:

### Structure Row

| | | | | | |
|---|---|---|---|---|---|
| | | | Tag Hierarchy | | |
| Tag Name | Tag Type | Tag Max ID | ID | Text | Attributes |

### Tag Name

This field contains tag names as per the HTML specification e.g. HTML, HEAD, BODY etc.

### Tag Type

The parsing engine classifies HTML tags into four categories:

| | |
|---|---|
| 1. | Start Tag |
| 2. | End Tag |
| 3. | Comments |
| 4. | Text |

This categorization enables the parsing engine to reduce each page into the smallest constituent parts that make sense when creating a portlet without sacrificing flexibility in the possibilities of selecting various portions of the page. Capturing start and end tags enables the system to know the units of which the page are made (for example, the start and end of a link indicate the complete link that needs to be captured if a user selects that link as the component they wish to turn into a portlet). Identifying comments enables the system to ignore these as gratuitous to the creation of the portlet. Similarly, text is identified because it is a portion of a unit (defined by a start and end tag) only in that it cannot be ignored and needs to be associated with whatever unit it is a part of.

### Tag Max ID

This is the frequency of a tag in the inspected HTML file. To enable the parsing engine to consistently track data within a page, and quickly parse a page over and over when updating the content via the caching operations, the tags are sequentially numbered.

### Tag Hierarchy ID

This field maintains hierarchy of table and tr tags. This helps in searching for the end tags of tr and table. The tag hierarchy is used for determining the compliance of a page with the HTML standards specification. It is also a key part in efficiently presenting display options to the end user. By measuring the depth in the page being considered, the present invention is able to provide a subset of all possible display options, reducing an otherwise high number of unlikely display options and making the portlet creation process more efficient.

### Example for Tag Hierarchy ID

| | |
|---|---|
| table | 1 |
| table | 2 |
| table | 3 |
| /table | 3 |
| /table | 2 |
| /table | 1 |

### Text

Text inside the tags is stored in this field. This text is associated with the tags, and when a tag is selected for display in a portlet, all the associated text is associated with the portlet as well.

### Attributes

This field contains list of name/value pair parameters that are associated with the tag being captured. The name/value pair possibilities are defined in the HTML specification and are essentially parameters to the tag.

### Exemplary HTML File

<HTML>

<HEAD>

<TITLE>Example</TITLE>
<SCRIPT language=“JavaScript” src=“test.js”>
</SCRIPT>
<SCRIPT language=“JavaScript”>

function myFunc() {

alert(“hello”);

}

</SCRIPT>

</HEAD>
<BODY onload=“JavaScript:myFunc();”>

<TABLE>

<TR>

<TD>

<TABLE>

<TR>

<TD>Inner Table</TD>

</TR>

</TABLE>

</TD>

</TR>
<TR>

<TD>Outer Table</TD>

</TR>

</TABLE>

</BODY>

</HTML>

### Data Structure After Parsing the Above HTML File

| Index | Value |
|---|---|
| | TagName |
| | Type |
| | MaxID |
| | HID |
| | Text |
| | Attributes |
| 1 | HTML |
| | Start Tag |
| | 1 |
| | 0 |
| | Null |
| | Null |
| 2 | HEAD |
| | Start Tag |
| | 1 |
| | 0 |
| | Null |
| | Null |
| 3 | TITLE |
| | Start Tag |
| | 1 |
| | 0 |
| | Null |
| | Null |
| 4 | TEXT |
| | Text |
| | 1 |
| | 0 |
| | Example |
| | Null |
| 5 | TITLE |
| | End Tag |
| | 1 |
| | 0 |
| | Null |
| | Null |
| 6 | SCRIPT |
| | Start Tag |
| | 1 |
| | 0 |
| | Null |
| | language |
| | JavaScript |
| | src |
| | test.js |
| 7 | SCRIPT |
| | End Tag |
| | 1 |
| | 0 |
| | Null |
| | Null |
| 8 | SCRIPT |
| | Start Tag |
| | 2 |
| | 0 |
| | Null |
| | language |
| | JavaScript |
| 9 | TEXT |
| | Text |
| | 2 |
| | 0 |
| | function myFunc( ) {alert(“hello”);} |
| | Null |
| 10 | SCRIPT |
| | End Tag |
| | 2 |
| | 0 |
| | Null |
| | Null |
| 11 | BODY |
| | Start Tag |
| | 1 |
| | 0 |
| | Null |
| | onload |
| | JavaScript:myFunc( ); |
| 12 | TABLE |
| | Start Tag |
| | 1 |
| | 1 |
| | Null |
| | Null |
| 13 | TR |
| | Start Tag |
| | 1 |
| | 1 |
| | Null |
| | Null |
| 14 | TD |
| | Start Tag |
| | 1 |
| | 0 |
| | Null |
| | Null |
| 15 | TABLE |
| | Start Tag |
| | 2 |
| | 2 |
| | Null |
| | Null |
| 16 | TR |
| | Start Tag |
| | 2 |
| | 2 |
| | Null |
| | Null |
| 17 | TD |
| | Start Tag |
| | 2 |
| | 0 |
| | Null |
| | Null |
| 18 | TEXT |
| | Text |
| | 3 |
| | 0 |
| | Inner Table |
| | Null |
| 19 | TD |
| | End Tag |
| | 1 |
| | 0 |
| | Null |
| | Null |
| 20 | TR |
| | End Tag |
| | 1 |
| | 2 |
| | Null |
| | Null |
| 21 | TABLE |
| | End Tag |
| | 1 |
| | 2 |
| | Null |
| | Null |
| 22 | TD |
| | End Tag |
| | 2 |
| | 0 |
| | Null |
| | Null |
| 23 | TR |
| | End Tag |
| | 2 |
| | 1 |
| | Null |
| | Null |
| 24 | TR |
| | Start Tag |
| | 3 |
| | 1 |
| | Null |
| | Null |
| 25 | TD |
| | Start Tag |
| | 3 |
| | 0 |
| | Null |
| | Null |
| 26 | TEXT |
| | Text |
| | 4 |
| | 0 |
| | Outer Table |
| | Null |
| 27 | TD |
| | End Tag |
| | 3 |
| | 0 |
| | Null |
| | Null |
| 28 | TR |
| | End Tag |
| | 3 |
| | 1 |
| | Null |
| | Null |
| 29 | TABLE |
| | End Tag |
| | 2 |
| | 1 |
| | Null |
| | Null |
| 30 | BODY |
| | End Tag |
| | 1 |
| | 0 |
| | Null |
| | Null |
| 31 | HTML |
| | End Tag |
| | 1 |
| | 0 |
| | Null |
| | Null |

What has been done so far is to have the user enter a URL (592 in FIG. 11), which identifies a page that gets retrieved and parsed (through the browse facility). The HTML is examined and categorized character by character. During this process, it is possible that embedded scripting is encountered.

When embedded scripting is encountered as at step 1304 in FIG. 13, the Markup (HTML) Parser hands control back to the Parsing Controller 252 which in turn passes control to the Scripting (JavaScript) Parser 264. FIG. 14 illustrates the data flow through the Scripting Parser.

The goal of the Scripting Parser is to modify the script so that it will execute properly within the system. Executing this script in such a way presents three main challenges.

The first of the major problems is that a script language that is embedded in a web page may wish to control the page. However, when that script is embedded in a portal page, containing many panes of information that are related but separate, the user would not wish that script to have control over the whole page. Therefore a script that controls the page must be modified to not control the page, yet the script must still function properly.

The second major problem is that we wish to pre-create and cache the portlet for performance reasons. This requires the system to act as a proxy on behalf of the user, and load the page and execute any scripts on the page. The problem is that the system's role as proxy is neither that of a traditional server nor of a traditional client. Further, the scripting which has been written expects to run on a server in a certain context. The system takes the script out of its environment, and runs it in its own. We therefore need to recreate the relationships the script has with other information such as including scripting files containing custom methods and other web pages.

The third problem is that we may not be able to find certain scripting methods that are custom to the source site and need to have a solution such that the scripting methods still function.

So, the three steps in the Script Parsing data flow (FIG. 14) involve calling the following three methods when a SCRIPT tag is encountered:

removeProblematicJS( ) (step 1306 in FIG. 14) to comment all problematic functions that can create a problem for the portlet because the JavaScript is executed on a server rather than by the user.

changeTagAttributes( ) (step 1308) to set the target attributes of anchor, area and form tags. These tags need to be reset because we are executing the script on our server, so we need the target attributes to reflect our server rather than the original server address

removeProblematicAllFunctions( ) (also represented by step 1306) to comment all problematic functions that cannot be found in user defined function lists and would therefore create problems for the portlet.

### Problematic JavaScript

This is the part of JavaScript that can cause problems while a portlet is being displayed because the JavaScript is meant to control the window in which the code executes. But the present invention runs the script in a ‘pseudo-window’ or pane within a bigger window. This script will now be sharing the bigger window with other portlets, so it cannot be allowed to control the window in a way that affects the other portlets. For example, a function of “close” in a portlet can cause the whole page to be closed, or a function of “back” or “forward” can move the user to some other page. The following are the functions that can cause problems and are removed by JSParser.

Close

Blur

Back

Forward

Go

Home

reload

stop

moveby

moveto

resizeto

resizeby

a. Change Tag Attributes

Changing tag attributes has the following steps:

1. make a clone of the data structure (to preserve the original)

2. Iterate the whole structure and append following string before the value of href attribute of all anchor (<A>) tags

strServer+

“Addportlet FromWeb.jsp?step=step1&txtAddURL=”

where strServer=http://IP:Port/CorpAdminportlet or http://IP:Port/CorpUserportlet

IP and port are that of the machine where the portlet Engine is deployed. The system knows these values because they are put in a configuration file or determined dynamically by the system. The decision on whether to use CorpAdminportlet or CorpUserportlet is based upon the context within the product. CorpAdminportlet reflects a portlet being created either for the repository or for the creation of a URL via the URL Generator. CorpUserportlet reflects a portlet being created in the user interface by an end user. The key point is that the HREF attributes of all anchor tags are re-written to properly execute when being executed from the server instead of from the original source.

3. Iterate the whole structure and set the target attribute of the base tag and form tag if they exist as “_top” and “_blank” respectively. If these tags exist, skip the next step, as it is no longer necessary.

4. If the base tag and form tags did not exist, Insert a base tag at the start of the structure with following attributes HREF=URL specified by the user and Target=“_top”.

5. Make a String by concatenating all the tags of the structure. This string in actual is the parsed HTML file, which will be shown to the user for browsing until he or she decides to add the page as a portlet.

Remove All Problematic Functions

Once these three steps are completed, the script is passed back to the parsing controller and put into the data structure. The Markup Parser then continues as before, categorizing the markup language into the data structure.

Overall, this whole procedure results in the conversion of a sophisticated web page into a concatenation of records in a data structure that is then on display for the user, in the portlet wizard as a representation of the original page. The user then has the option to create a portlet from either the composite panes, forms or links within the original page. Selecting a pane, form or link directs the user to the next step.

### Selecting Pane Format

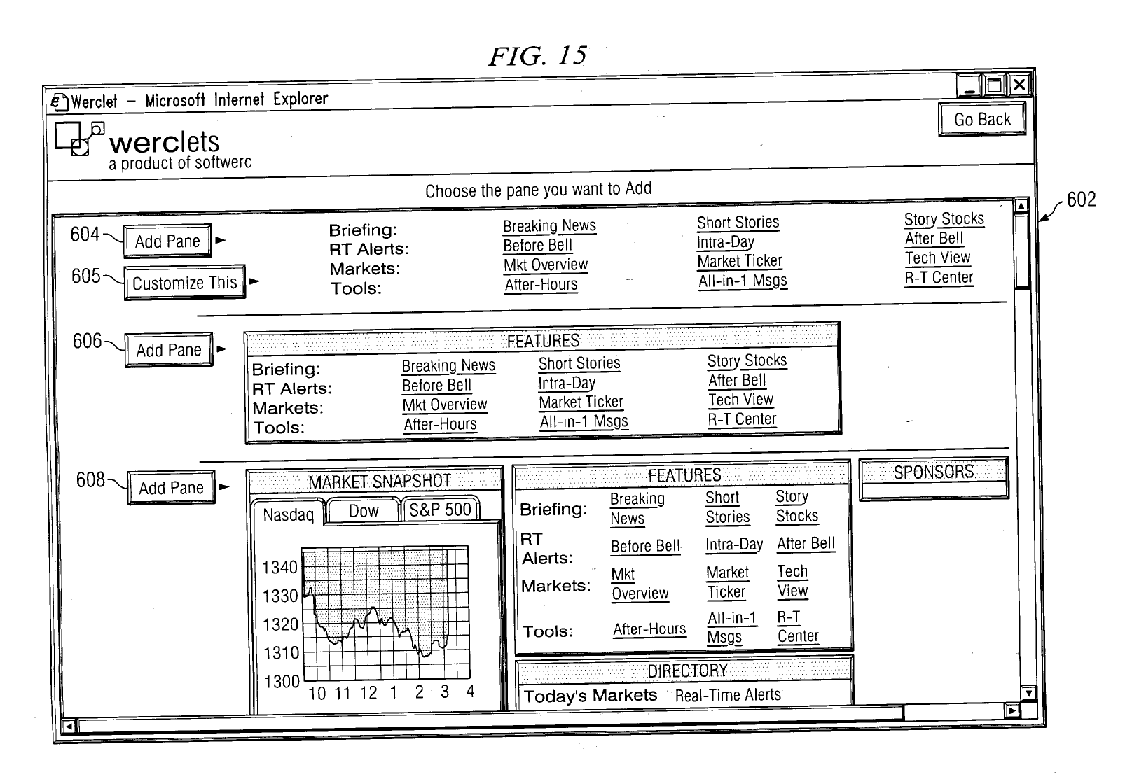

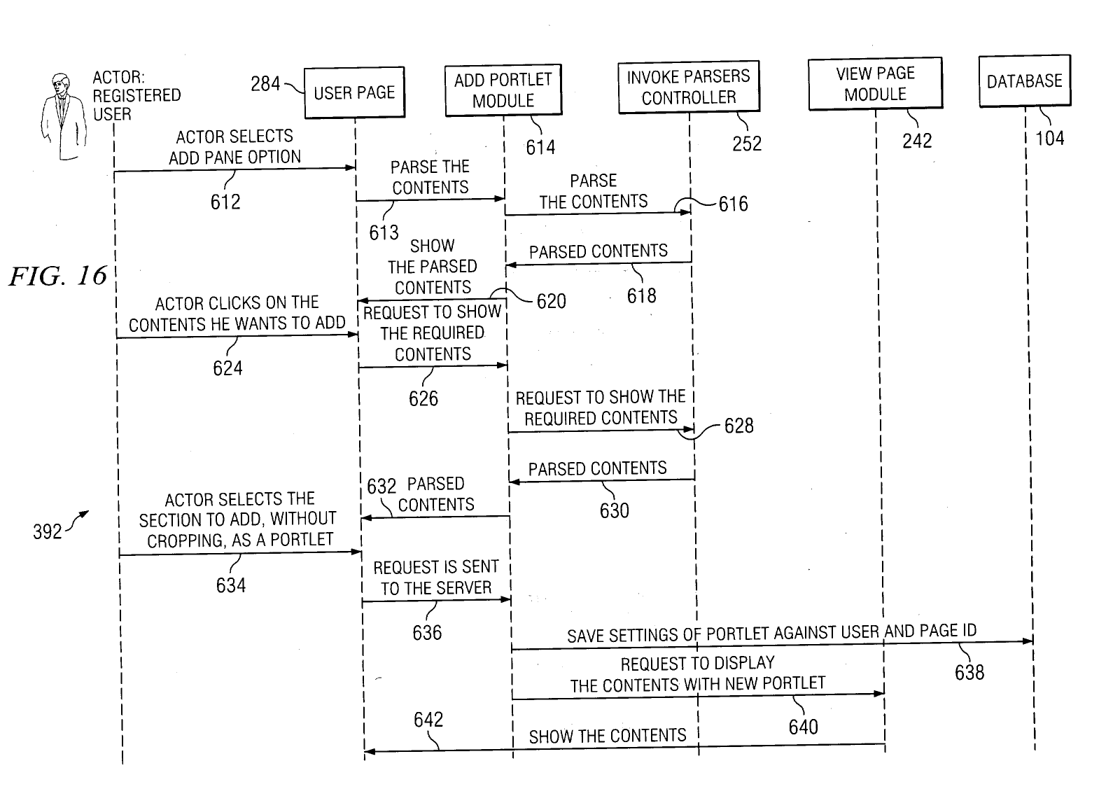

Once the pane format is selected (selection 590 in FIGS. 10 and 15) and the user hits “go” (button 591), the contents of the page are parsed completely again (FIG. 10, step 613), including all script parsing, and the resulting data structure is iterated (1004) through for presentation in the portlet wizard (FIG. 16).

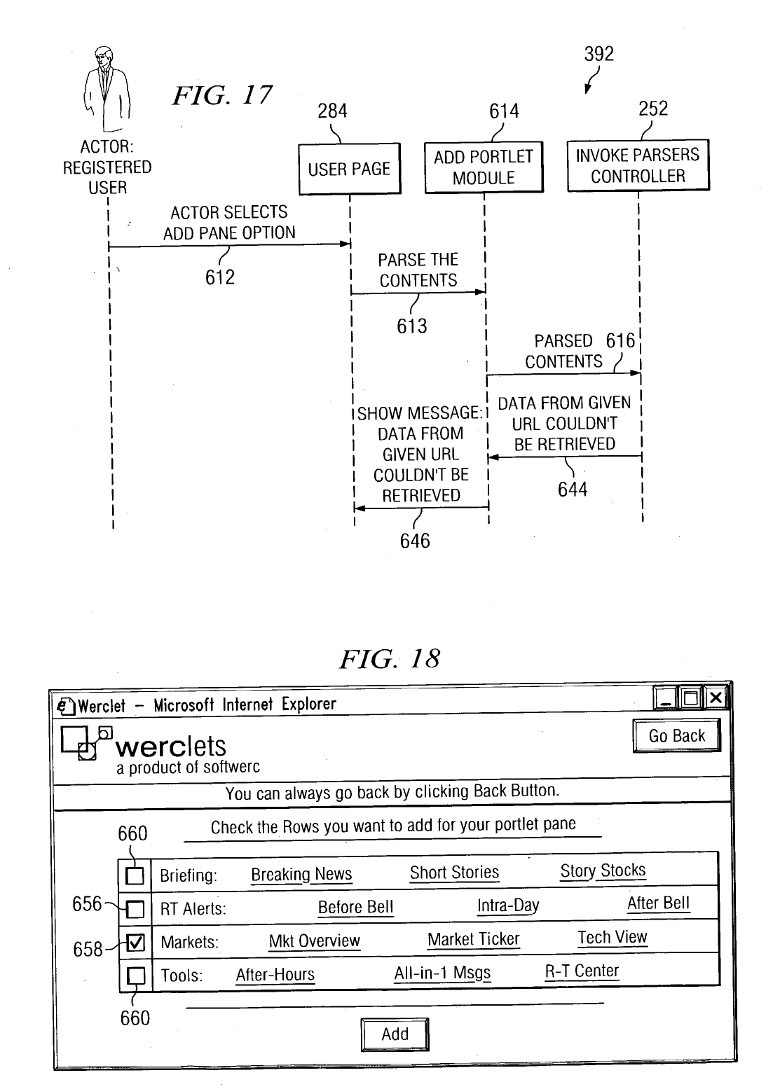

FIG. 17 represents the UML sequence diagrams of the operations involved in building a portlet from a pane of information. In the event that the URL entered by the user is un-retrievable, FIG. 18 represents the UML definition of how the invention returns an error message to the effect that the URL could not be retrieved.

In FIG. 17, at 612, the user selects the “add pane” option on the user page 284 in the portlet wizard. The user page 284 passes the URL and an indication that the user wants to add a pane of information to the Addportlet Module 614 in step 613. Module 614 resides on the server 100 and coordinates all the remaining steps required for the addition of a portlet to the system. Module 614 first invokes the parser controller 252 at step. 616. The parser controller parses the already parsed data structure using the process as defined above with the following two differences: text is made selectable and links are modified so that a mouse-over pop-up gives users a hint on how to proceed.

First, text is made selectable. Second, links are modified to work within the system, along with the additional insertion of a mouse-over pop-up that gives the user a hint by requesting that they select a portion of the text (605 in FIG. 16).

Returning to FIG. 17, at 618 the parser controller 252 passes the parsed contents back to the Addportlet Module 614 which in turn passes them back, at 620, to the UserPage module 284. These parsed contents are presented to the user by the UserPage module so that the user can click on the section he or she wishes to add to the portlet. It is important to realize that the page has changed. At this point, the substance of the links has been changed so that they don't function as links anymore. The intent is for them to be selected so that the system can determine what part of the page the user wants to display in the portlet.

At step 624, the user clicks on a particular portion of the page. At step 626 the UserPage module 284 passes to the Addportlet Module 614 the index that represents what was selected, which includes the Tag Hierarchy ID and Tag MAX ID, to uniquely identify the part of the page that was selected.

At step 628, this index is then passed from the Addportlet Module 614 to the ParserController 252. The ParserController 252 creates various presentation options from which the user can choose the best fit. Specifically, not every single theoretical presentation option is displayed. The present invention is designed to present the most likely combination of presentation options to the user, often reducing ten's of choices down to a handful. Three such choices are shown in the top, imaged end of the Wizard page shown in FIG. 16.

The method for preparing the presentation options follows:

1 make a clone of the data structure

2. search the immediate table above the index, get the table number from the data structure

3. iterate from the start of the table to the end of the table. If Form contents are present inside the table, but the form start or end is outside the table, check if there are hidden fields above or below and inside the form, then concatenate all the tags iterated and store this concatenated string in a data structure along with information on whether the table is crop-able or not. The table is crop-able if it doesn't have an inner table and has more than one row.

4. If the form contents above or below the table are not hidden, then the method searches for the outer table, and so on until the total form is selected. The method uses this total form in the presentation as a display option

5. Search the parent of that immediate table, following steps 3/4/5 to make a string, and store this string in a data structure. Finish when the final choice is the entire structure, and again store this in its own data structure.

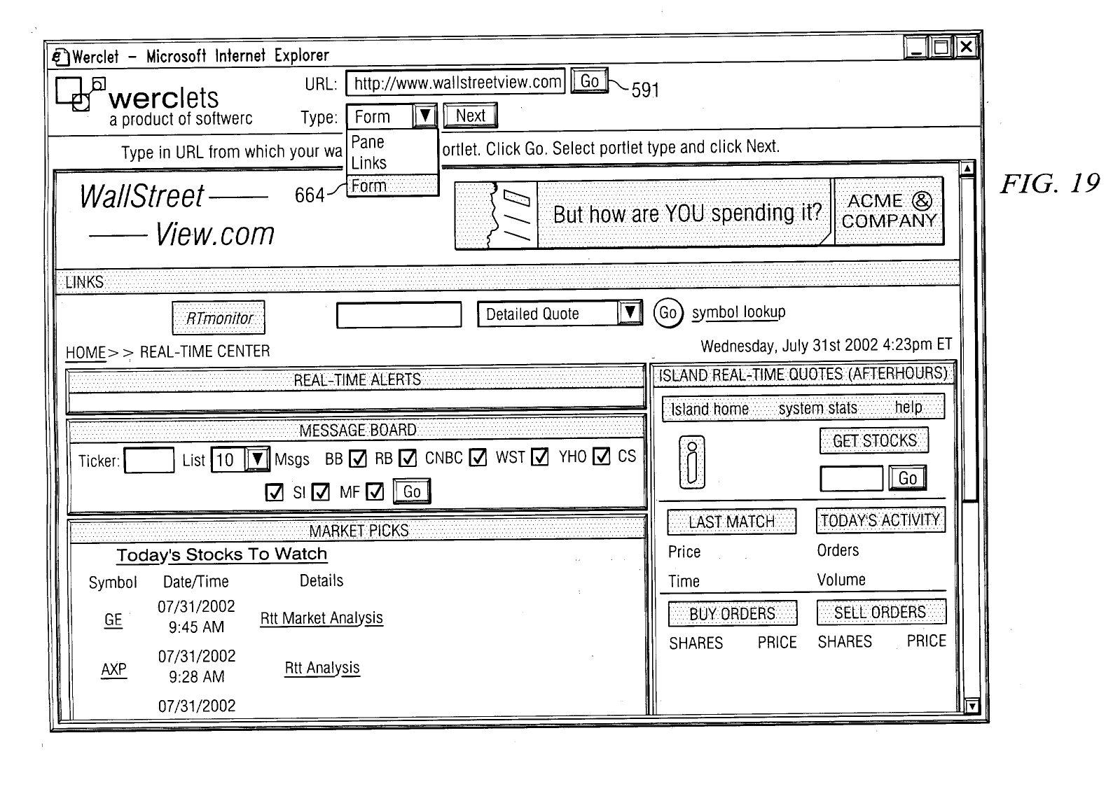

We also have the opportunity to allow cropping of a portlet if there is no inner table, and the pane has more than one row. The user is then able to crop the pane prior to finalizing the creation of the portlet. In our user interface, we add a button called “customize this” (605 in FIG. 16) if a pane is croppable. When selected, the user is provided with the opportunity to select particular rows 656, 658, 660 in the pane to display as part of the portlet (FIG. 19). In the portlet definition that Addportlet Module 614 stores in the database 104 are the row numbers to display as part of the portlet.

In either case, whether cropping or not, the user (FIG. 17, step 634) then selects which section to add to the portlet (FIG. 16). That information is sent at step 636 (FIG. 17) from the UserPage 284 module to the Addportlet Module 614 which is responsible for saving the portlet in database 104 with all the associated parameters.

When creating a portlet in the user interface, the users are creating the portlet for ‘immediate consumption’ rather than for storage for use later. Therefore, in that situation, step 640 initiates a request to the ViewPageModule 242 to display the contents of the new portlet which in turn sends the contents 642 for display to the UserPage module 284. Additionally in the illustrated embodiment, when saving the portlet in this situation, the Addportlet Module 614 saves it in an area defining the portal page, rather than in the repository area, where portlets are stored for re-use.

### Selecting Form Format

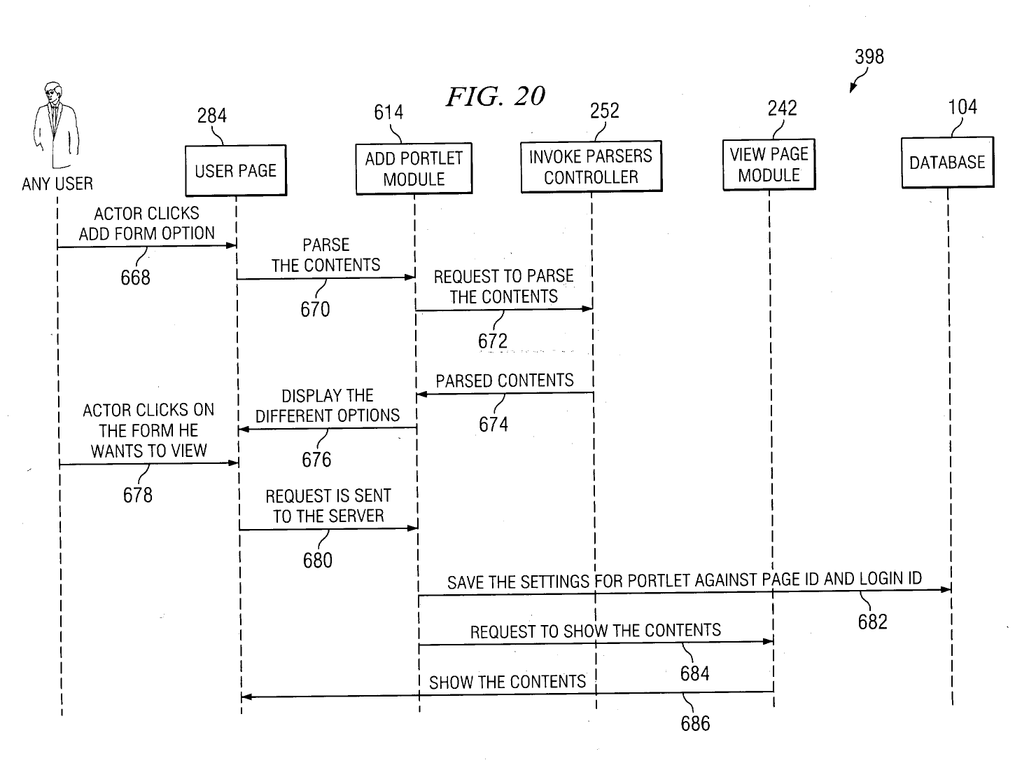

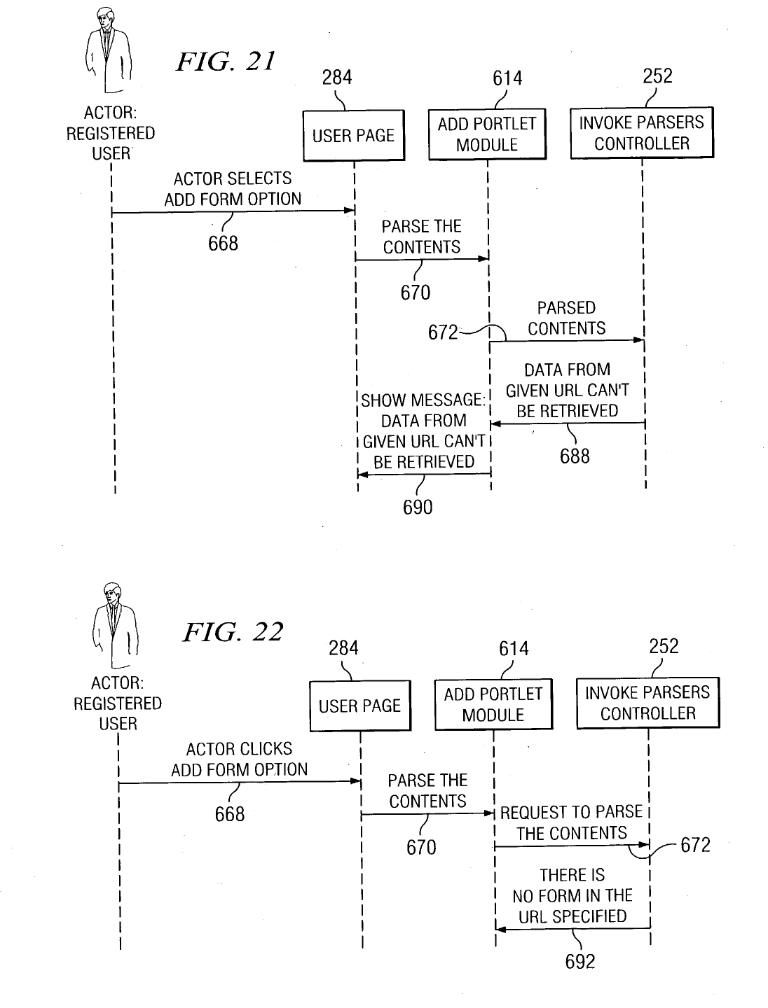

Once the Form format is selected (664 in FIGS. 10 and 20; 668 in FIG. 21) and the user hits “go” (591 in FIG. 21), the contents of the page are parsed (670, 672) completely again, including all script parsing. However, with Forms the user doesn't have the same flexibility to choose from a section of the page because of the nature of forms. Typically, a form is self contained and therefore the parser parses the page to pull out each form within the page, presenting each separately to the user for portlet creation.

The process for finding forms is as follows:

1. Iterate through the whole data structure and search for forms.

See step 1006, FIG. 10.

2. When a start tag of a form is encountered, iterate until its end tag if there are no tables, or if all tables are totally contained within the start and end form tags.

3. If a table exists within the form whose start or end is not inside the form, search above form-start-tag and below form-end-tag for missing start and end table tags until a matching start and end are found. Concatenate all the above tags and store it in a data structure. The idea is to take a complete form that doesn't contain any incomplete tables. Repeat from #2 above until the end of the document.

4. Return the data structure which now contains all the forms.

The UserPage module 284 (FIG. 21) receives the data structure, and iterates through it to display all the forms present in the page so that the user can select the form they wish to create a portlet from.

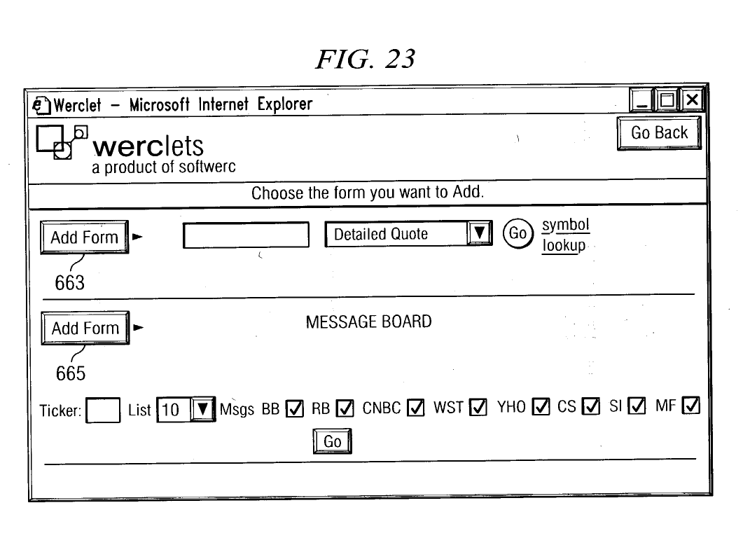

FIG. 21 represents the UML Sequence Diagram of the operations involved in building a portlet from the forms on a page. In the event that the URL entered by the user is un-retrievable, FIG. 22 represents the UML definition of how the invention returns an error message to the effect that the URL could not be retrieved. FIG. 23 represents the UML definition of how the invention returns an error message to the effect that the URL selected to parse has no forms in it.

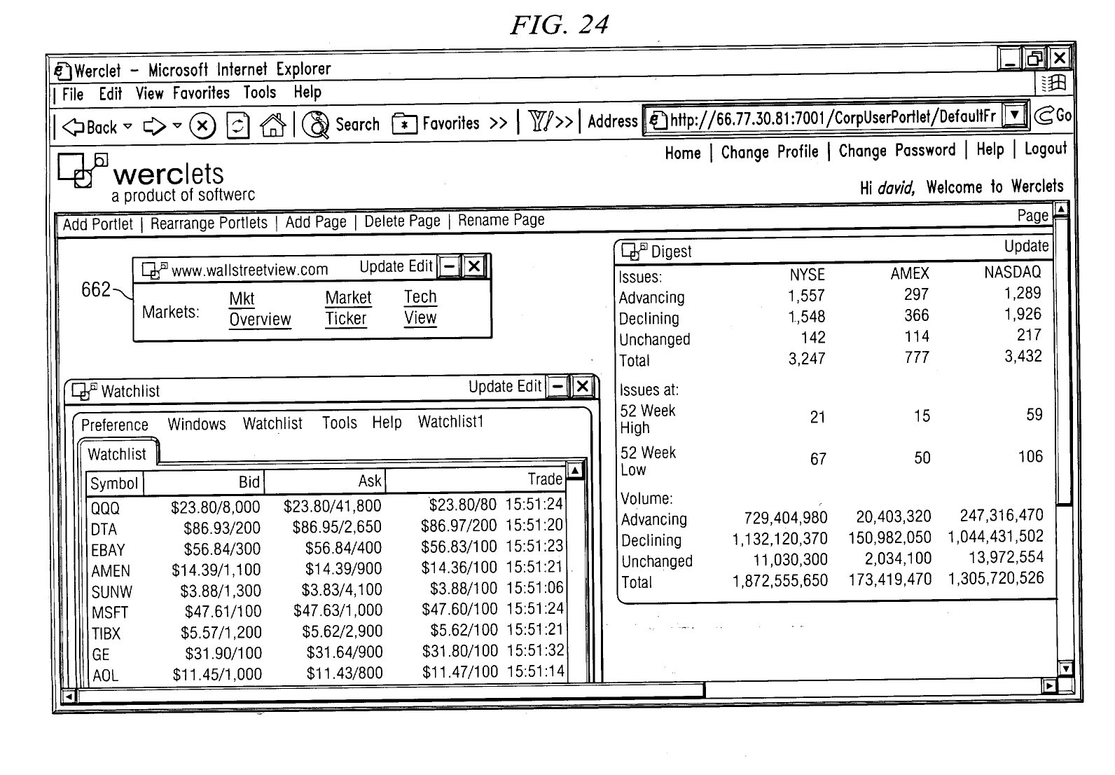

After the UserPage module 284 displays the forms 663, 665 on a page (see FIG. 24), the user selects one form, as by selecting form 663. See steps 676, 678 in FIG. 21. This selection is sent back at 680 to the server, where the Addportlet Module 614 saves the settings at 682 in the database 104.

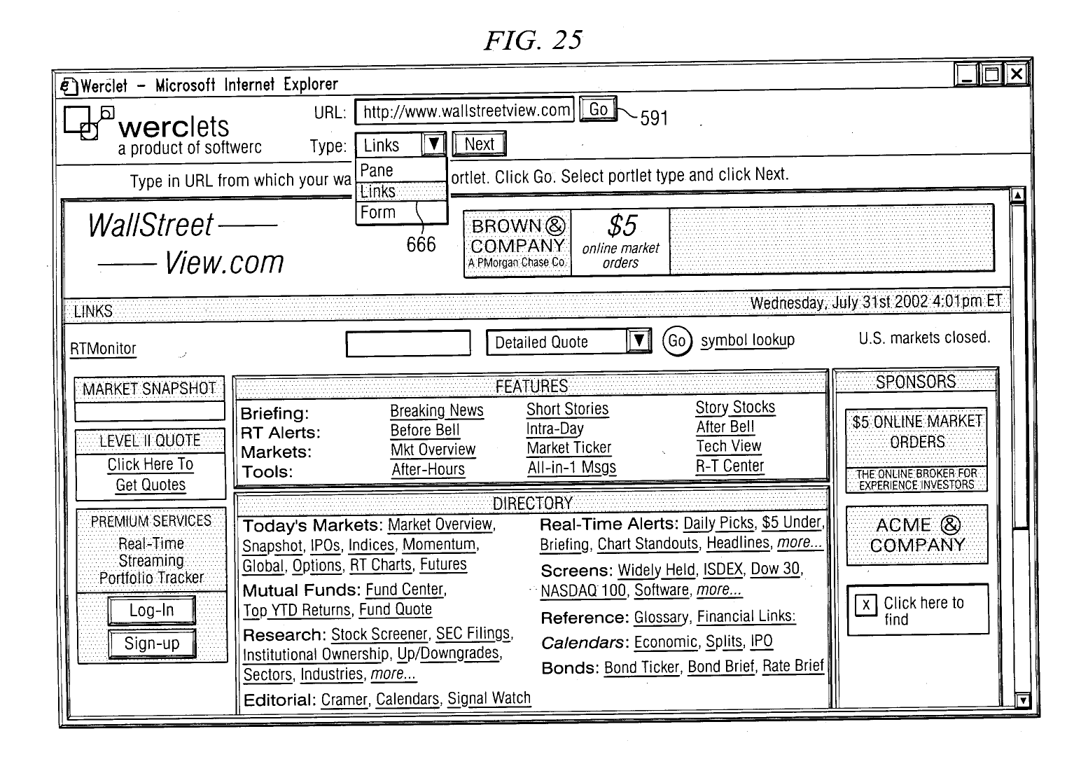

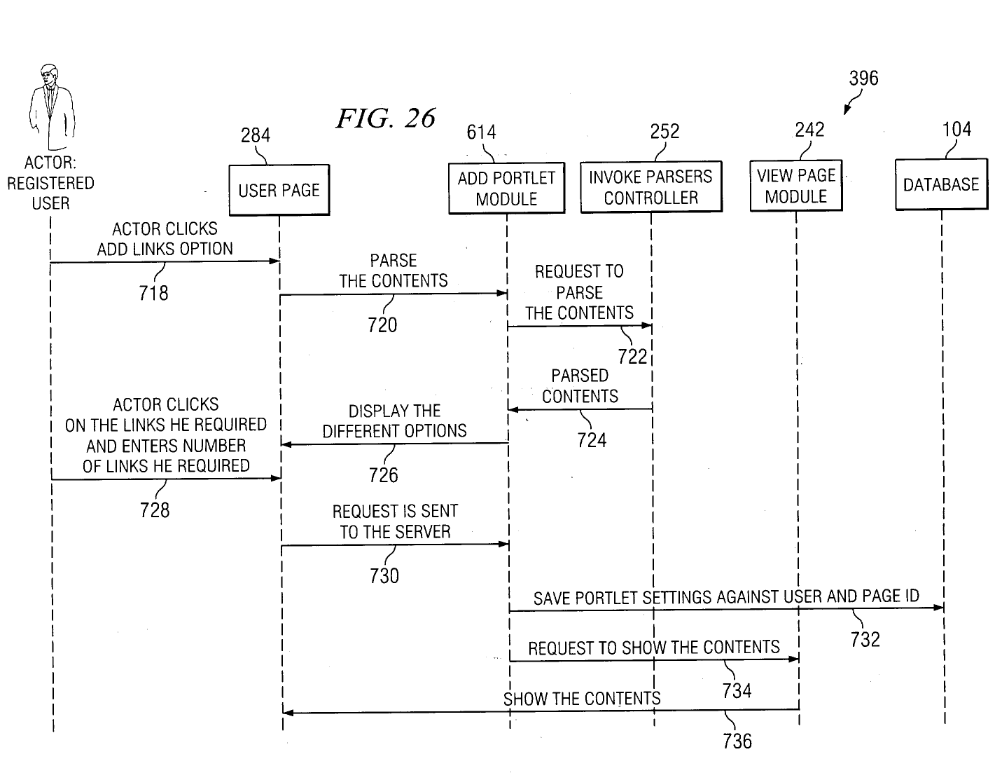

As was the case for panes, when creating a portlet in the user interface, the users are creating the portlet for ‘immediate consumption’ rather than for storage for use later. Therefore, in that situation, Addportlet Module 614 in FIG. 21 initiates a request step 684 to the ViewPageModule 242 to display the contents of the new portlet. ViewPage module 242 in turn sends the contents, at 686, for display to the UserPage module 284 for display. Additionally by convention, when saving the portlet in this situation, the Addportlet Module saves it in an area defining the portal page, rather than in the repository area, where portlets are stored for re-use. FIG. 25 shows a selected form 662 displayed on the user portlet manipulation screen or user page.

### Selecting Links Format

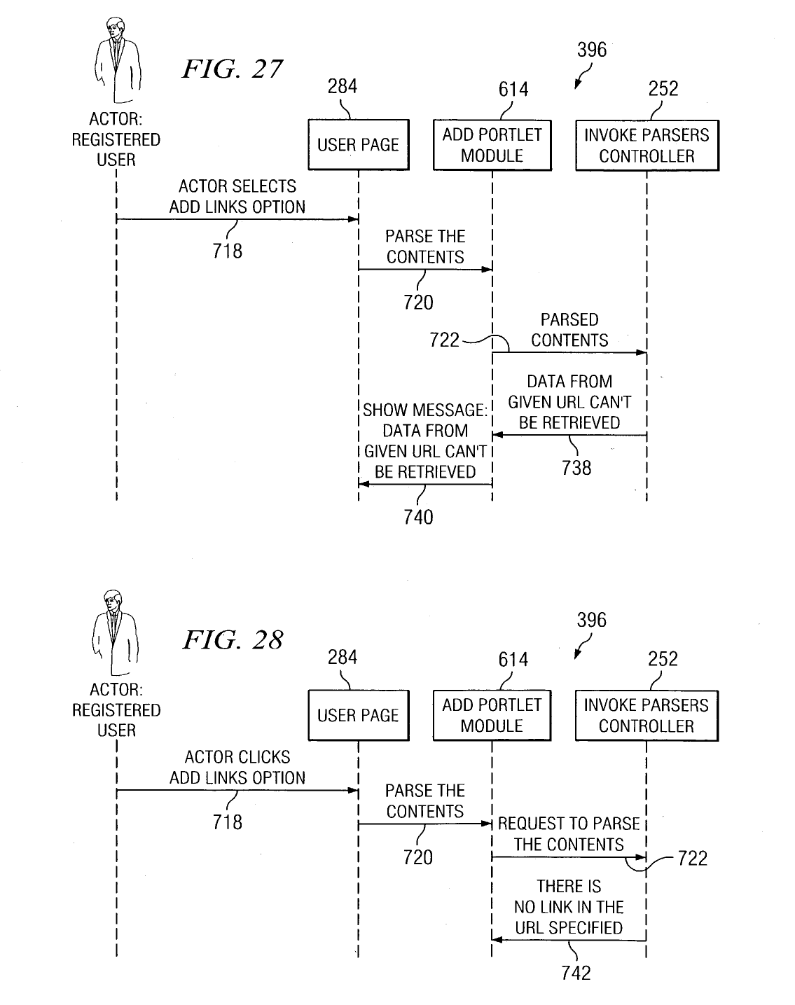

Once the Links format is selected (666 in FIGS. 10 and 25; 718 in FIG. 27) and the user hits “go” 591, the contents of the page are parsed completely again, including all script parsing.

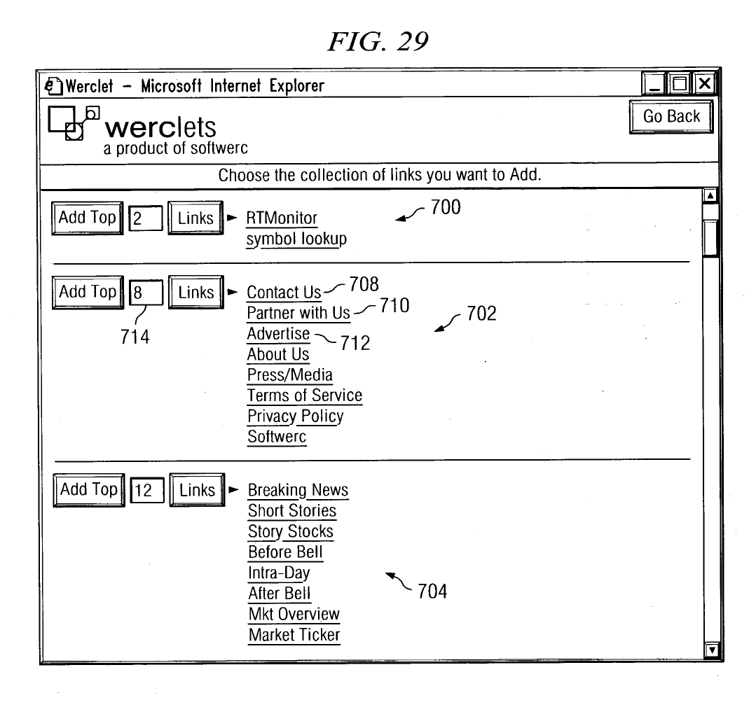

The Sequence Diagram for adding links is represented in FIG. 27. FIG. 28 represents the UML Sequence Diagram for how the invention returns an error message when the URL cannot be retrieved. FIG. 29 represents the UML Sequence Diagram for how the invention returns an error message if the selected URL contains no links.

Referring to FIG. 27 the process for showing all the links in a page follows:

1. The user clicks the add links option in the UserPage module 284. The UserPage module passes the request at 720 for a links parsing of the page to the Addportlet Module 614, which in turn requests at 722 that the Parser Controller 252 parse the page.

2. The parser parses the entire page again, including all script parsing.

3. It then iterates through the whole structure. See step 1008, FIG. 10.

4. When a start table in encountered, it iterates until the end table searching for anchor tags.

5. For each anchor tag, if it is around an image, the system ignores it, and the system removes class and color attributes of anchor tags.

6. Concatenate all the anchor tags from the beginning of the table and make a string.

7. Store the string in a data structure.

8. If there is still an open table, make a string out of all links from the beginning of the table and go back to step 4. If the end of the table is reached, continue iterating through the page until the end, and go back to step 4 if a new table is encountered.

9. Return the resultant data structure at 724 to the AddPageModule 614, which in turn passes it to the UserPage 284.

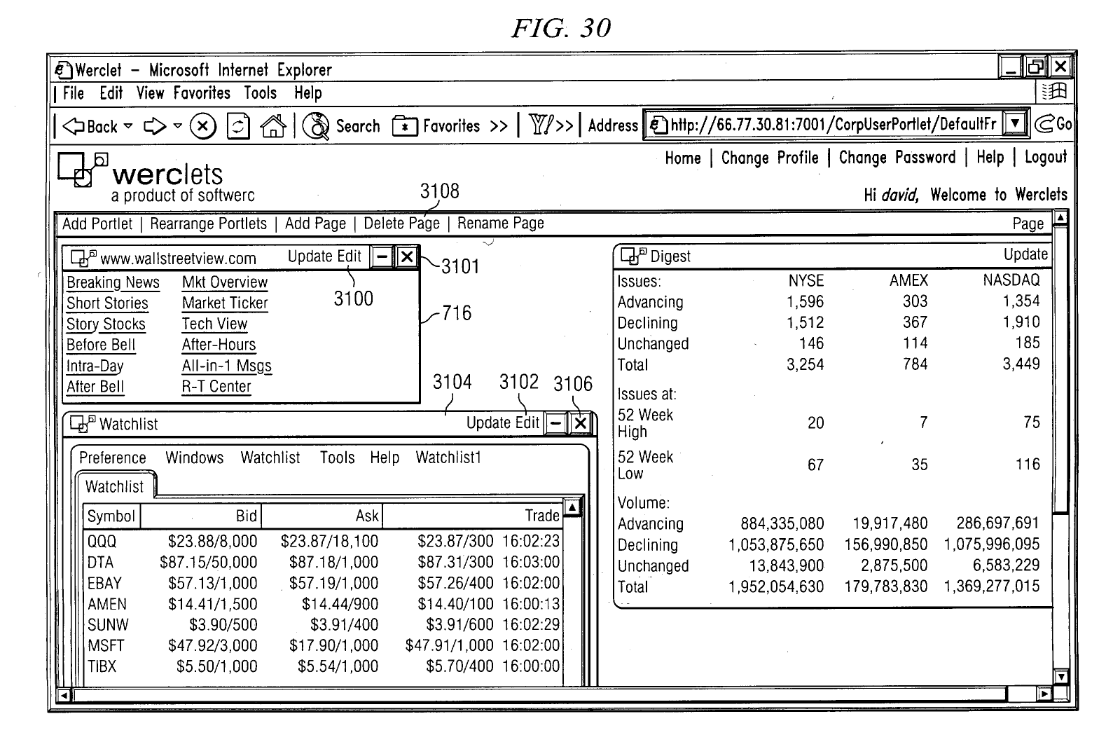

10. UserPage 284 iterates through the returned data structure and all the links in the page are shown to the user, at 726, grouped so that the user can select the group of links they want in the portlet. FIG. 30 shows the user interface screen (sometimes termed by the inventors the “WERCSPACE”) with three groups 700, 702, 704 of links. The user must also select at 728 a modifier representing how many of the links should be shown in the portlet. This is shown at 714 in FIG. 30. The default number of links shown in the portlet is the number of links in the section from which the portlet is being created. For example, a section 702 with eight links (including links 708-712) will have a default of showing eight links, whereas another section (such as section 700) from the same page with only two links will have a default value of showing two links.

After the UserPage module 284 displays the links on a page (FIG. 30), the user selects one section, shown at step 728 in FIG. 27. This selection is sent back at 730 to the server, where the Addportlet Module 614 saves, at 732 the settings in the database 104.

As in the pane and form selections, when creating a portlet in the user interface, the users are creating the portlet for ‘immediate consumption’ rather than for storage for use later. Therefore, in that situation, Addportlet Module 614 initiates a request step 734 to the ViewPageModule 242 to display the contents of the new portlet, which in turn sends the contents at 736 for display to the UserPage module 284. Additionally in this embodiment, when saving the portlet in this situation, the Addportlet Module 614 saves it in an area defining the portal page, rather than in the repository area, where portlets are stored for re-use. The resultant exemplary link-based portlet is shown at 716 in FIG. 31.

### Cache Server

In order to optimize the performance, and in fact, to achieve any reasonable amount of scalability, we have implemented a caching server 102 (FIG. 1) to augment the performance of the parsing engine.

The cache server 102 serves three main functions: removing portlets from the cache 103, adding portlets to the cache 103 and updating portlets in the cache 103. When called, the cache server 102 is sent a JMS (Java Message Service) message by the parsing engine 100 that either tells it to remove a portlet or to add/update a portlet.

The sequence for when the message tells the caching engine to add/update a portlet is as follows. First, the details of the portlet are read from the message. Second, these details are written to a list that keeps track of all portlets that need to be updated. Finally, the cache initiates the download of the portlet, writing over the original contents if this is an update, adding them to the cache if it's a new portlet.

If the message had been to remove a portlet, the portlet is deleted from the cache and removed from the update portlet list.

### Editing a Portlet

From the various places where portlets can be managed (URL Generator, user interface, and Administrator's Console) the user is presented with the ability to edit a portlet. Being able to edit a portlet gives the user flexibility to change the portlet should the original source change, rather than requiring the user to recreate the portlet from scratch.

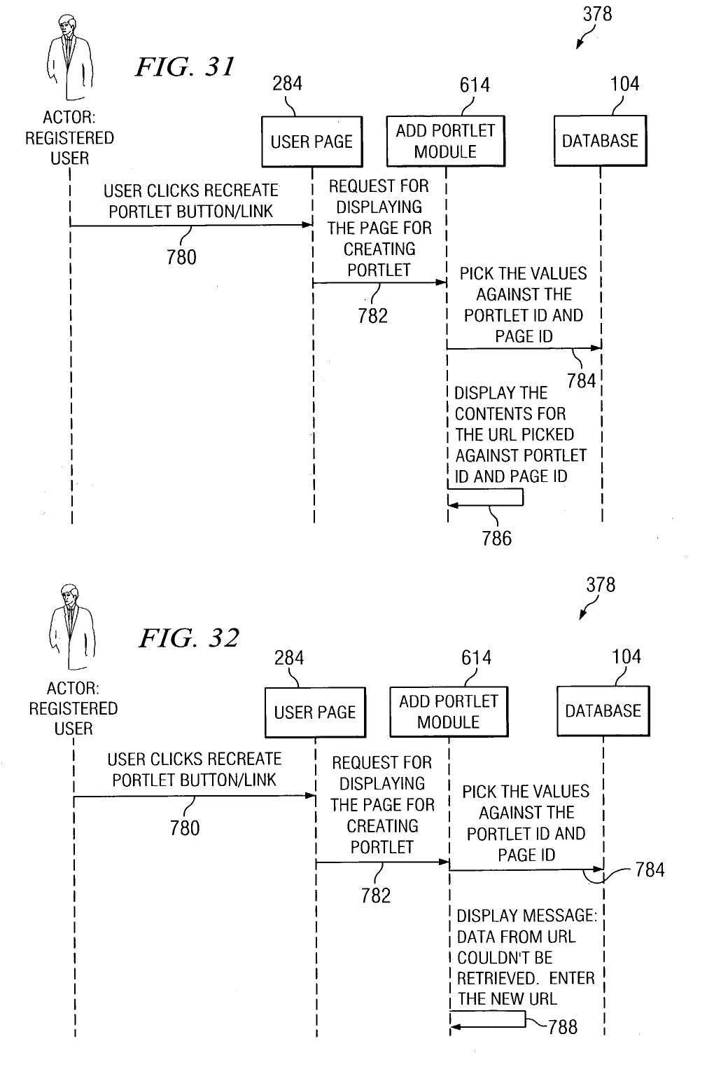

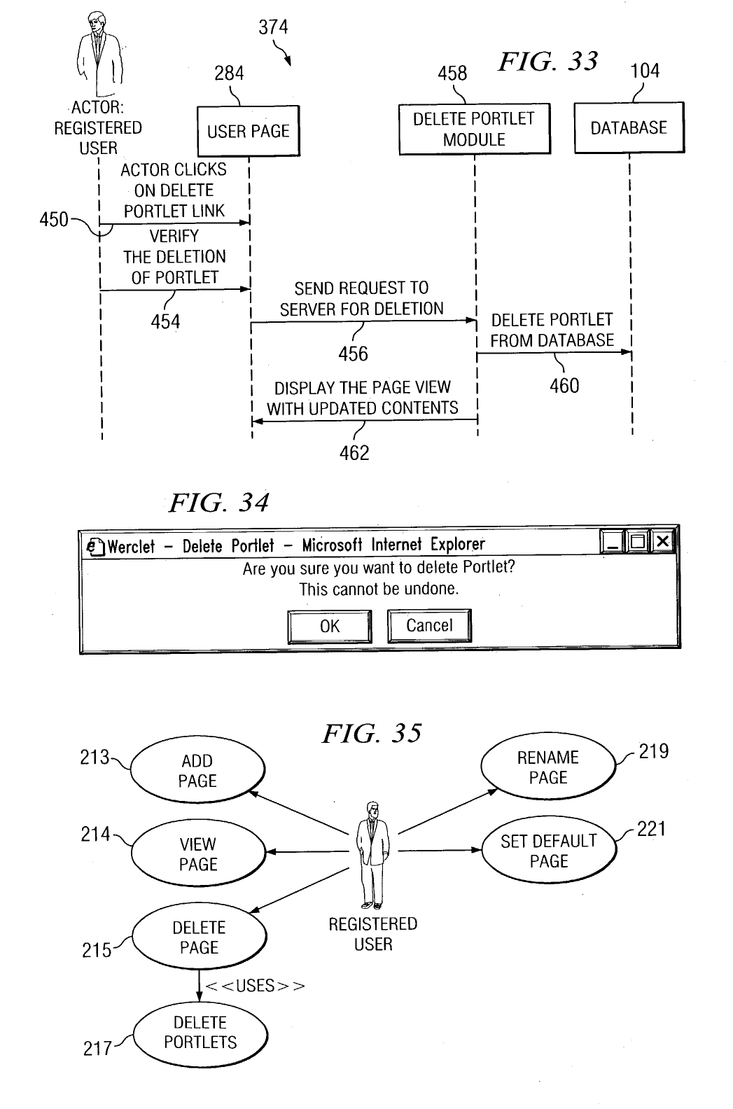

When a user chooses to recreate a portlet (FIG. 32), at 780 the user clicks the ‘edit’ button in the upper right of the portlet pane. “Edit” buttons can be seen, for example, at 3100 and 3102 in FIG. 31, disposed in panes 716 and 3104, respectively. Returning to FIG. 32, the UserPage module 284 then passes at 782 a request to add portlet module 614 for displaying the page for creating the portlet along with the wercletID and PageID so that the specific portlet can be identified. The Addportlet Module 614 uses these ID's to retrieve the portlet from the database 104 and then at 786 displays the contents in the portlet wizard. The process from here for recreating the portlet is the same as the original creation, except the URL and other parameters the user selected are pre-filled into the fields so that the user can see what was entered before, and may choose to leave them alone if he or she doesn't wish to change those particular parameters. If the URL could not be retrieved, a message is passed to the user to that effect, and they are prompted to enter the URL. This is represented in a sequence diagram in FIG. 33.

In the event that the portlet cannot be retrieved by the Addportlet Module 614, the return message 788 indicates so, and suggests that the user enter a new URL.

Adding portlets 384 and rearranging portlets 376 are described in detail elsewhere in this document.

FIG. 34 shows the sequence diagram for deleting individual portlets. At step 450, the user clicks on the ‘x’ in the top right corner of the portlet pane, seen, for example, at 3100 in FIG. 31. The UserPage module 284 asks the user to verify the deletion, because in the illustrated embodiment the deletion is permanent. When confirmed at 454, the UserPage 284 sends, at 456, the portlet ID along with a request for deletion 456 to the Deleteportlet Module 458. The Deleteportlet Module 458 deletes, at 460, the portlet from the database. The portlet is only deleted from the area of the database that represents the user's page. If the portlet were stored in the repository, the portlet would still be available for addition to the page from the repository. If the portlet were a portlet created by the user at some previous time and not stored in the repository, the deletion of the portlet would be permanent, and the user would have to recreate it from scratch if they wish to replace it on the page once it's deleted. For this reason, the system sends the warning shown in FIG. 35 prior to deletion.

### Operation from the User Viewpoint

Users will access the parsing and presentation capabilities of the system through the portlet wizard, which in turn can be accessed in this embodiment from one of three places: the administrative console, the user interface, and the URL Generator.

The administrative console is used to manage users and to manage the repository. The repository is a database of portlets created centrally for access either through the user interface by users or through the URL Generator by portal administrators who build portals with third party portal products. The administrative console provides useful support for the product, but is not central to the invention.

The user interface and the URL Generator are described below.

User Interface

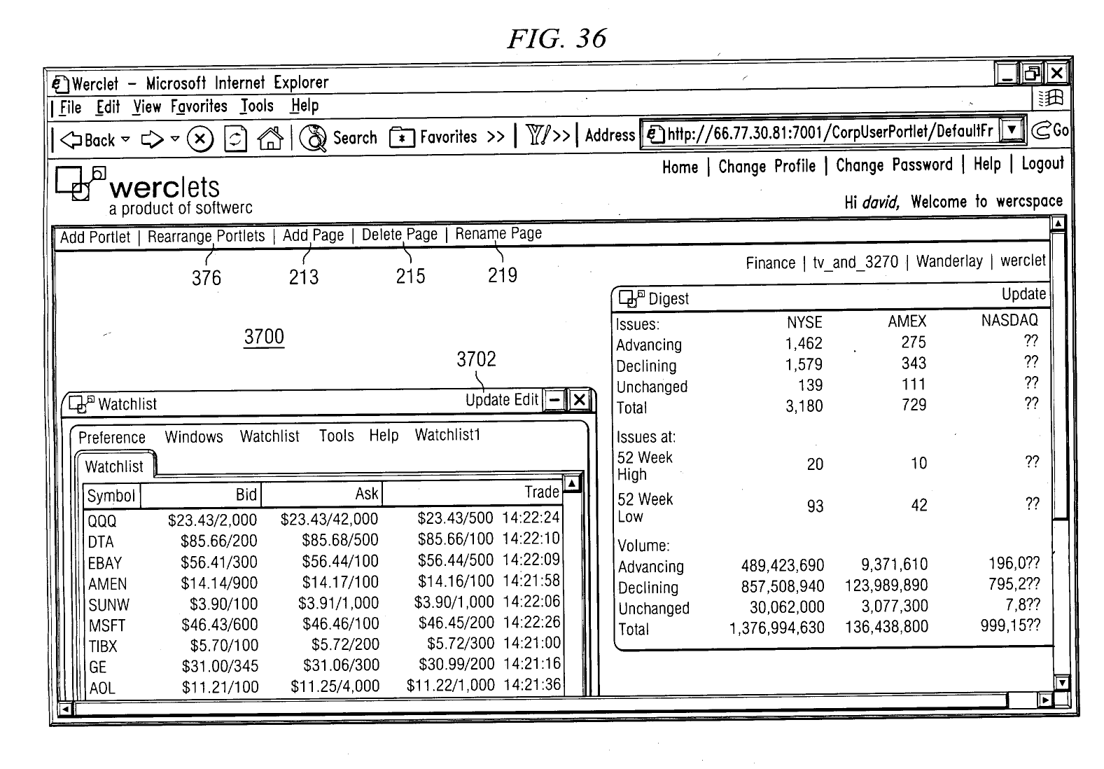

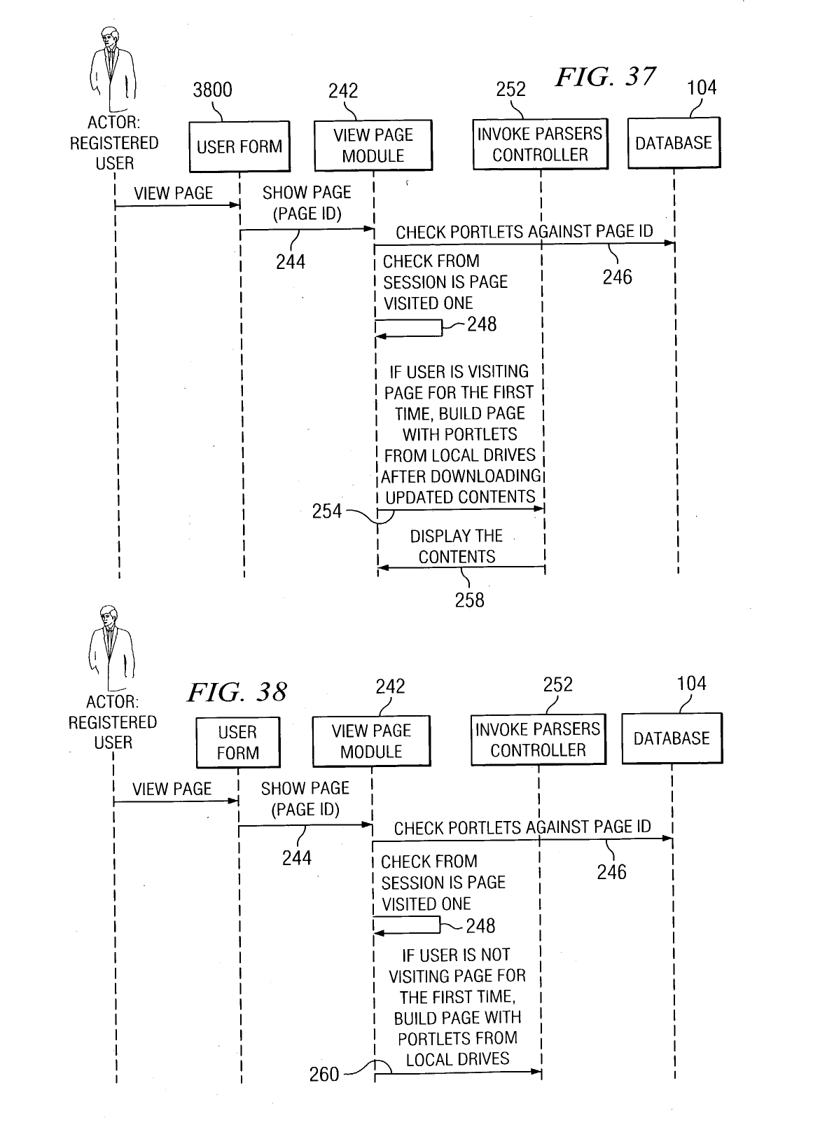

The user interface is a portal interface that uses a multi-page format with tabs to switch between pages. The interface supports common features such as the ability to perform operations on pages, such as add, delete and rename, and operations on portlets such as minimize/restore, delete, rename, and manually refresh. These page and portlet features are described in detail in the next section of this description. The different choices afforded to the user interface are shown in FIG. 36. A representative user interface is shown at 3700 in FIG. 37.

The three key differentiating features of the user interface 3700 are the ability to rearrange portlets (217) within a page in a free-form manner, individually refreshing portlets (“update”, 3702) to improve system efficiency, and using a repository of portlets that treats a portlet as an object, enabling a user to drag a portlet from the repository into the page.

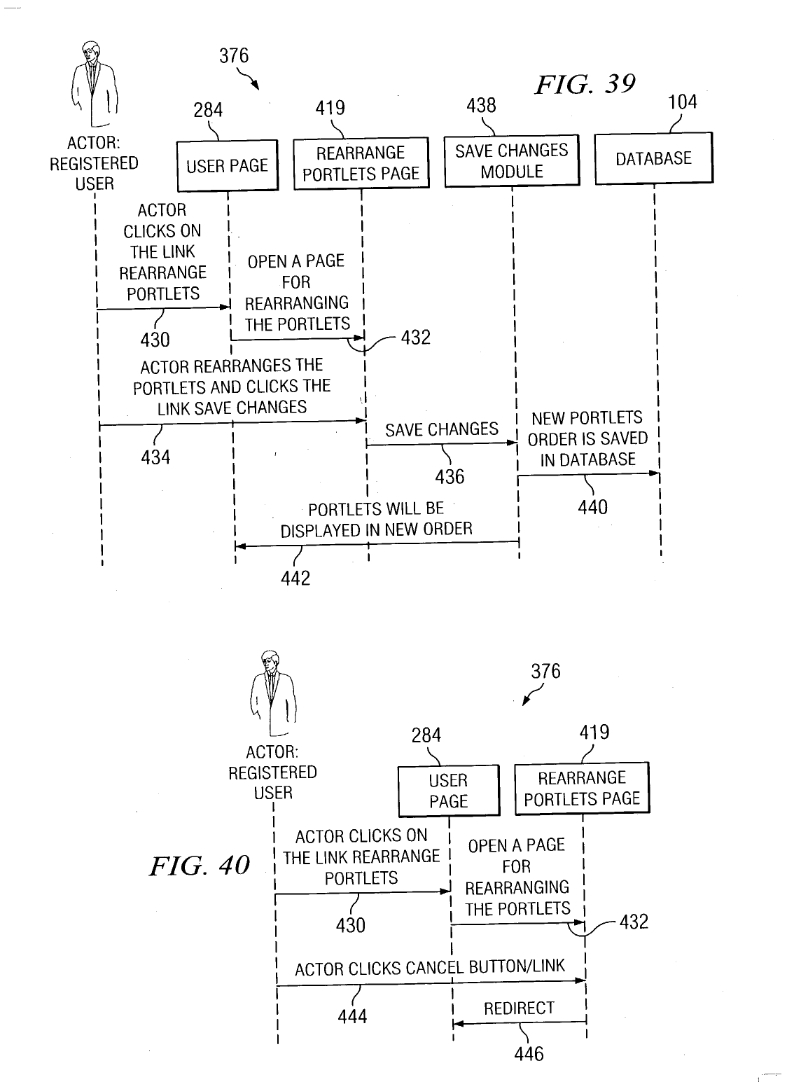

Enabling this functionality is the way that we've built the user interface page. The View Page Module 242 (FIG. 38) is responsible for building pages. The steps for loading a portlet the first time it's loaded into a page include: (1) Create portlet DIV (tags) on the page, (2) attach an IFRAME to this portlet, (3) load the Viewportlet .jsp in the IFRAME, and (4) when the portlet's requested contents are completely loaded in the Viewportlet .jsp assign them to the portlet. If the portlet has already been loaded, but is being refreshed (the condition occurring in FIG. 40), there are only two steps: (1) set the IFRAME to Refreshportlet .jsp and (2) when the portlet's requested contents are completely loaded in Refreshportlet .jsp, assign them to the portlet.

This page design is the enabler for all other page properties.

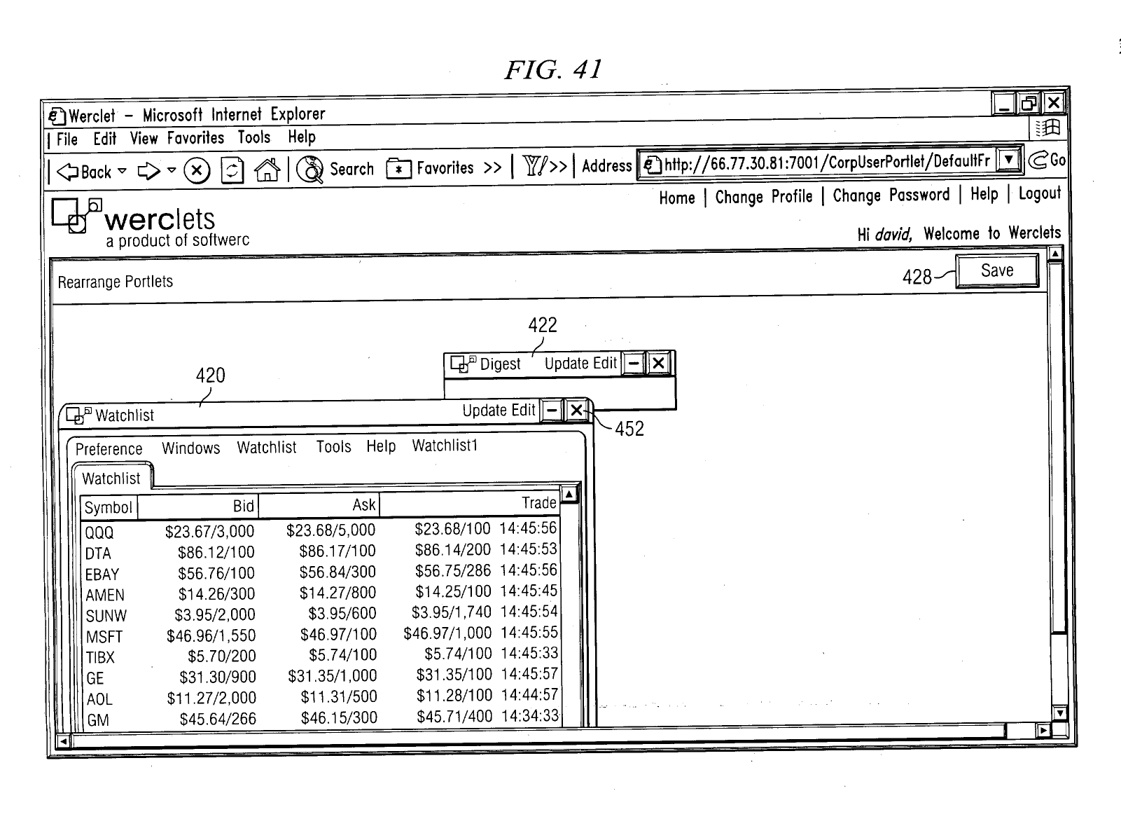

Rearranging portlets (FIGS. 41-43) is an interesting feature because all other products restrict users to laying out portlets in a row/column format. In other portal products, rearranging is limited to switching a portlets column, and rearranging the order within a column. In fact, most portals require that the portlet be designed in such a way as to be in ways restrictive as to which column the portlet can be in. Specifically, most portal pages have a 1, 2 or 3 column layout. With these layouts, one of the columns is often wider than the others, allowing wider formatted portlets. A wider format portlet cannot be put in any but a wide column.

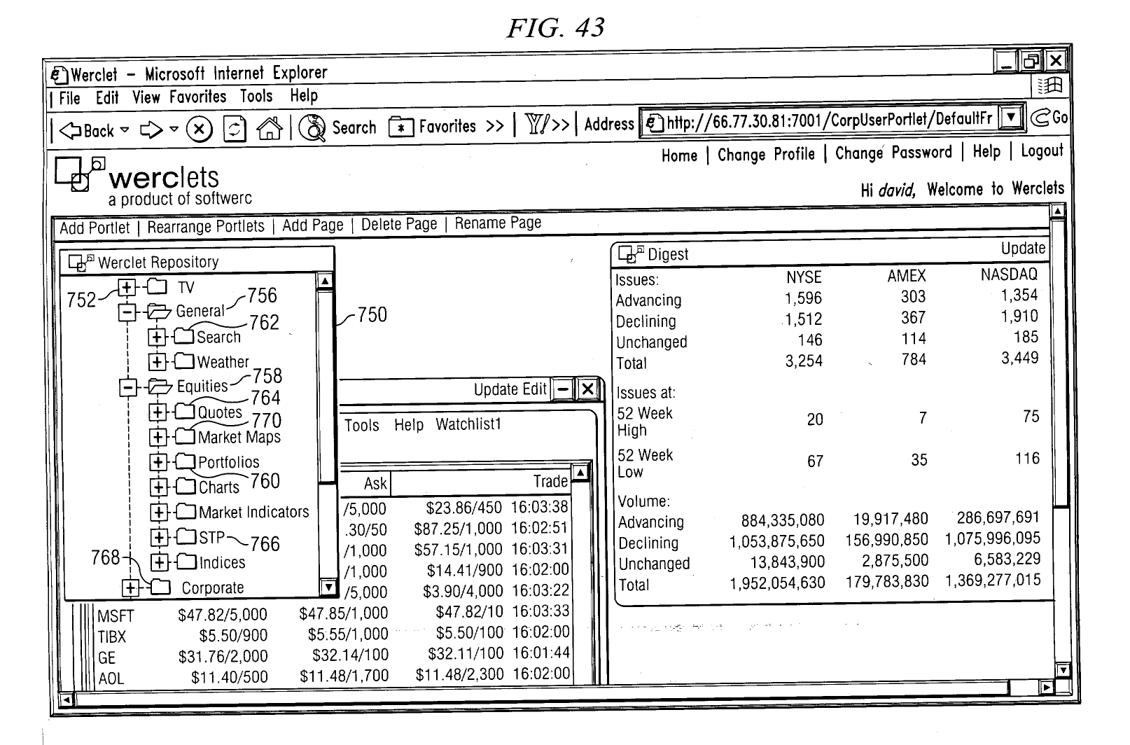

With the user interface of the present invention (FIG. 43), users (not just portal administrators) can drag on the pane bar 420, 422) to move a portlet anywhere in the page they'd like, including overlapping the panes. This feature is significant in that it changes a portal from being like a newspaper in format to being more like the user's Microsoft WINDOWS® desktop.

Rearranging portlets is accomplished by having fields in the portlets database for the vertical and horizontal positions of the portlet as well as the “Zlndex”, which is a measure of layering that we have created, so that we can layer the portlets properly. The invention uses IFRAMES to capture the vertical, horizontal and layered placement of the portlet, and JavaScript to capture the motion on the screen associated with dragging and dropping the portlets within the page. These two capabilities are combined to provide a browser page that allows full positional control over portlets in the page.

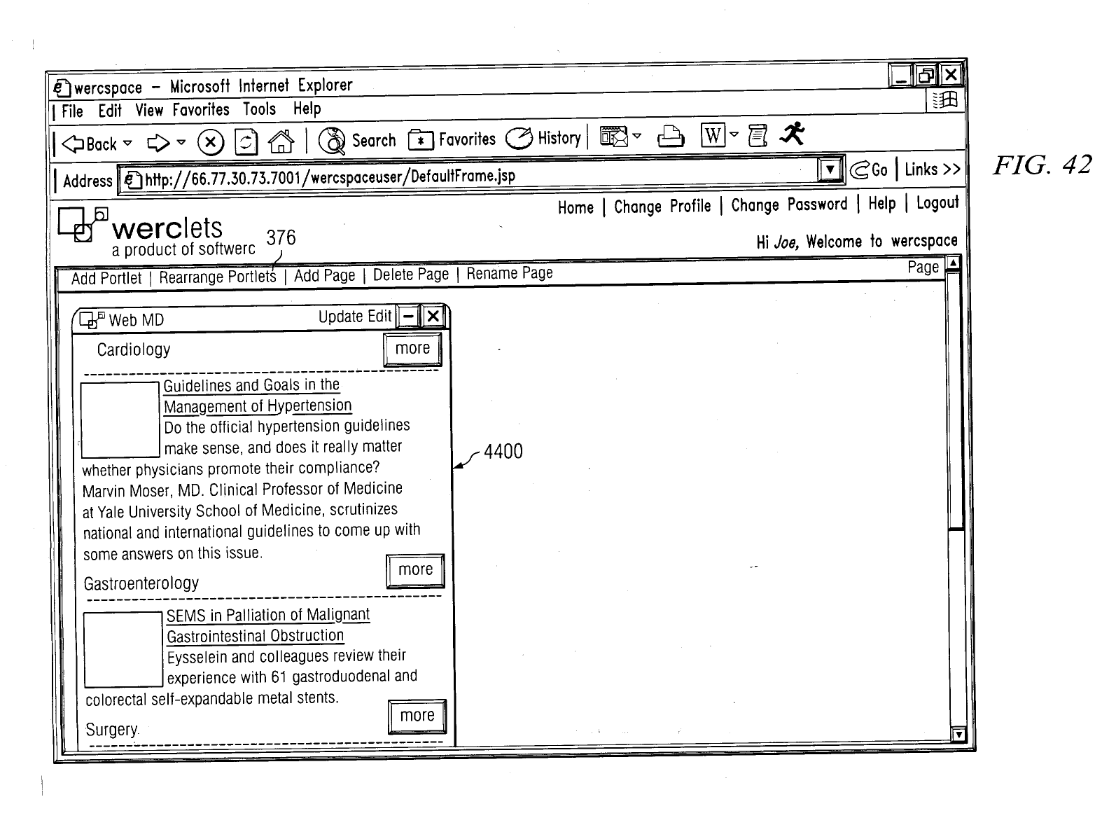

As shown in FIG. 43, users must click on the rearrange werclets button 426 to start the rearrange process. As shown in FIG. 41, the main rearrange portlets sequence diagram, clicking button 426 (action 430) causes the UserPage module 284 to open, at 432, a page for rearranging the portlets. At this point, the user at 434 can click on the pane bars 420, 422 and rearrange the portlets however the user wants. At any point, the user can click cancel, and the page will be restored the way it started by refreshing the page from the database (FIG. 42, sequence diagram).

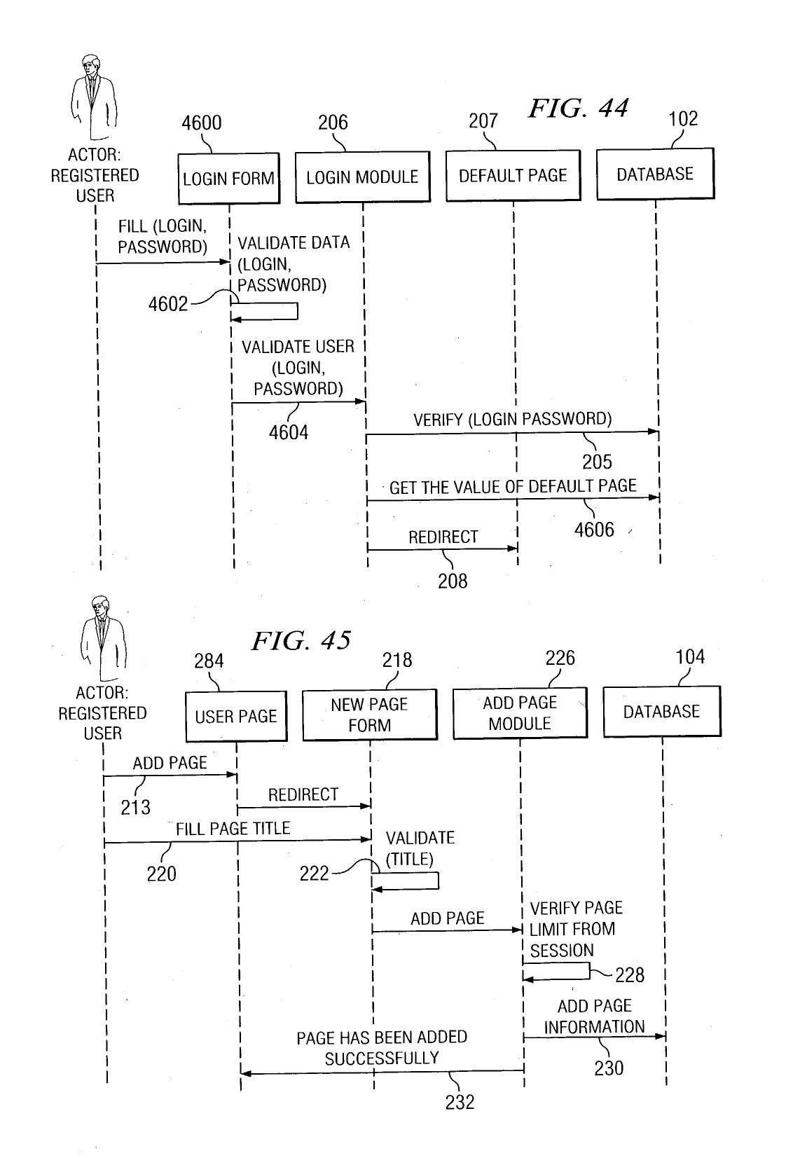

Under the covers, there is a three step process responsible for enabling the rearrange feature (see the screen of FIG. 44). When a user presses on the mouse button on a portlet pane bar 217, the selection is registered and the specific portlet 4400 is identified as is its location using the method Registerportlet (portlet ID) found in portlet U122.js. Next, as the portlet is dragged on the page a method Moveportlet( ) is attached to the onmousemove event of the body of the java server page (jsp). This allows the java server page to update the location of the window as it is being dragged across the page. Finally, when the user releases the mouse, the UnRegisterportlet( ) method is called which causes the horizontal, vertical and layer position of the portlet to be stored by accessing this information in the IFRAME.

Once the user has completed the process of rearranging the page, clicking save 428 (FIG. 43) causes the SaveChangesModule 438 to store the new layout of the page by reference to each portlet by horizontal, vertical and layered position on the page in the database 104. Once saved, the SaveChangesModule 438 (FIG. 41) causes, at 442, the UserPage module to display the new order.

Another unique feature of the user interface is the ability for the user interface to refresh each portlet independently of the others. Upon creation, each portlet is assigned a refresh rate by the portlet creator. In a portal, where there are a variety of common sources with different update frequencies, it is very efficient to be able to update each individually.

When the refresh interval expires, the JavaScript used to create the portlet in the user interface knows and sends the parsing controller a message to update the portlet and passes the required portlet ID. The ParserController then goes out to the source and rebuilds the portlet to ensure that it is built from the latest available source. The ParserController makes sure this latest up to date portlet is stored in database 104 and then passed back to the ViewPage module to be displayed within the user's page.

In addition to the scheduled version of refreshing a portlet, we provide a button in each pane that allows the user to initiate this process manually (described below; see “update” button 3702 in FIG. 37).

Instead of retrieving a new portlet from the Web or writing a custom portlet, a user can instead retrieve one or more portlets from a repository. The identities and certain other characteristics of these portlets have been stored by the administrator of the system in a repository. FIG. 45 illustrates a step in retrieving such a portlet. Referring briefly back to FIG. 12, for this path the user selects “add portlet from repository” 530. The “tree”, shown at 750 in FIG. 45, gives the internal structure of a portlet repository. In this embodiment, we have given the repository two layers which we call echelons and brackets within which portlets can be stored. One representative echelon 754 is shown here, and three representative brackets 756, 758 and 760. Each of the brackets, and perhaps ones of the echelons as well, will have portlets (representative ones of which are shown at 762, 764, 766, 768, and 770).

These portlets have been downloaded and possibly edited, or created in the first instance or read from other sources, by the administrator for the server on which the parsing engine resides. The repository stores those characteristics of each portlet necessary for the retrieval thereof from a source URL. The administrator can make the entire tree 750 available to any particular registered user, or only particular echelons or brackets thereof. These permissions are stored against the user ID in database 104. To add a portlet from this pre-approved repository 750 of portlets, the user simply clicks on one of them in the tree, and drags it to the user interface.

Dragging portlets from a repository and dropping them on a page is implemented in much the same way as rearranging portlets on a page are.

URL Generator

The URL Generator is a user interface that provides access to the parsing and presentation capabilities for portlet creation and provides as its output a URL as a reference to the portlets stored in the database. This differs from prior art in that the portlets of the invention are stored in a cache/database system that's scalable, while at the same time users can have a simple URL to access them. Other conventional products that provide a URL store the portlet in a directory, and don't have access to the portlet as a unit for manipulation. Finally, since the system uses the same portlet wizard to access the unique parsing and presentation capabilities described above, the URL Generator also captures the unique functionality already described in this disclosure.

The procedure is as above for portlet creation. However, once the portlet is created and stored in the database, the system returns a URL to the UserPage module. The URL is stored along with the portlet parameters in the database and can be accessed by a user at any time after the creation of the portlet.

The technical advantage of the URL Generator is rapid integration of portlets created with our invention into third-part portal products, such as BEA WebLogic™ or Sun Microsystems' SunONE™ Portal server.

### Operation of Certain Implementation Features

There are many ancillary features that are part of the illustrated embodiment of the invention. This section will provide details about the implementation of these features.

Logging Into the System

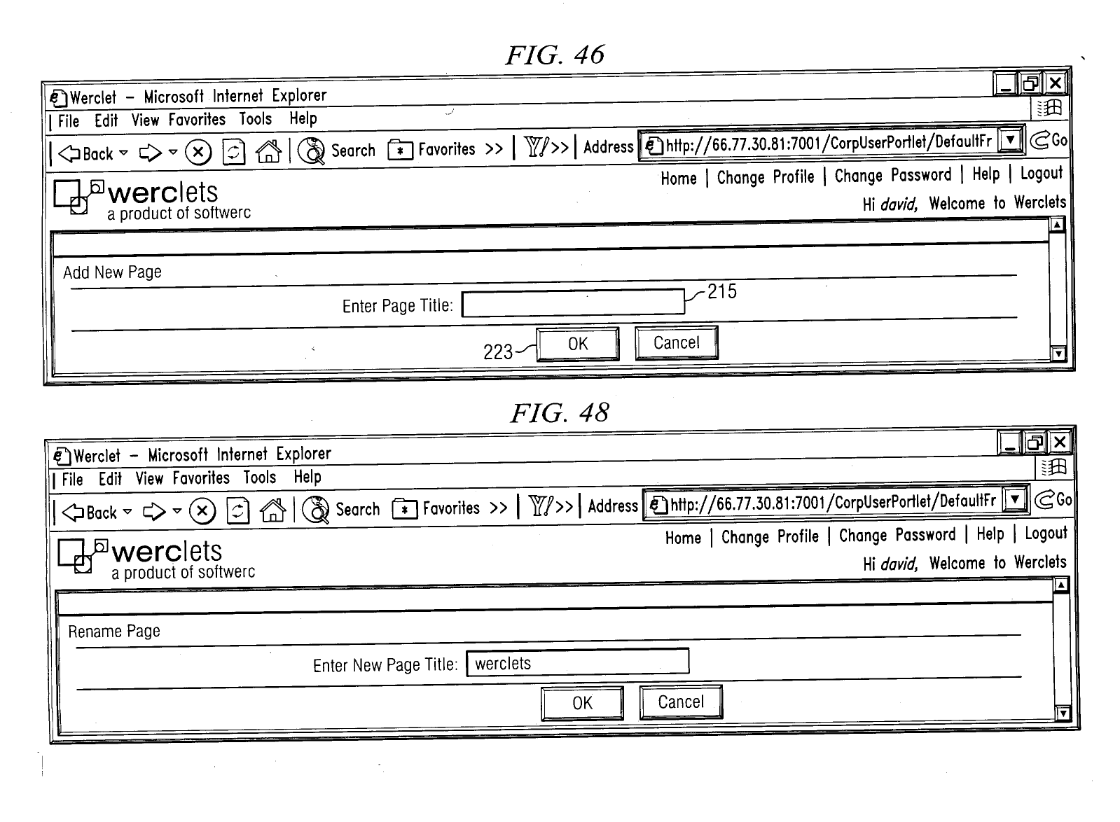

Users log in to the system to access the portlet creation and, if not using a third party portal product, to access the portlet viewing facility, the user interface. FIG. 46 presents the Sequence Diagram for the login facility. In the illustrated embodiment implementation, there are three separate situations in which a user might log in. We provide three choices to keep the user interface simple. In other embodiments, these three interfaces could easily be combined. The three situations are: logging into the administrative interface, logging into the URL Generator, and logging into the user interface. The administrative interface is used to set up new users for the user interface, set up new administrative users, and to create portlets for storing in the shared repository.

A user enters a username and password into the LoginForm module 4600, which validates the data (4602) by checking that the length of each is at least 2 characters and does not contain any forbidden characters. If the data cannot be validated, the user is prompted to re-enter the data. Once the data is validated, it is passed, at 4604, to the LoginModule 206 on the server which verifies, at 205, the data against the database 104. If the data cannot be verified against the database, the user is prompted to re-enter the data. Once the username and password are verified against the database, the LoginModule then retrieves, at 4606, the default page associated with this login and redirects, at 208, the user to their default page.

When a user logs in but does not belong to a user group, they are a member of the default group “guest”. The guest group members are, in this embodiment, unable to do anything and after logging in simply receive a message that they are part of the guest group and must see their administrator.

Other User Interface Features

FIG. 36 is part of the UML definition for the user interface and defines the actions that a user of the user interface can initiate on a page.

The user interface is a multi-page portal interface, similar to a spreadsheet, where the interface has a number of tabs (also called pages), and the interface displays a single page at a time. When the user account is set up by an administrator, the user is placed in a user group. Each user group has a default page associated with it. In the illustrated embodiment there are five pages per user account, with a limit of 15 portlets per page. In this embodiment, we have decided to let the default page only be modified by the administrator, to let the user have total control over the contents in the remaining four pages.

As seen in FIG. 36 the user can add pages 213, view pages 214, delete pages 215, and rename pages 219.

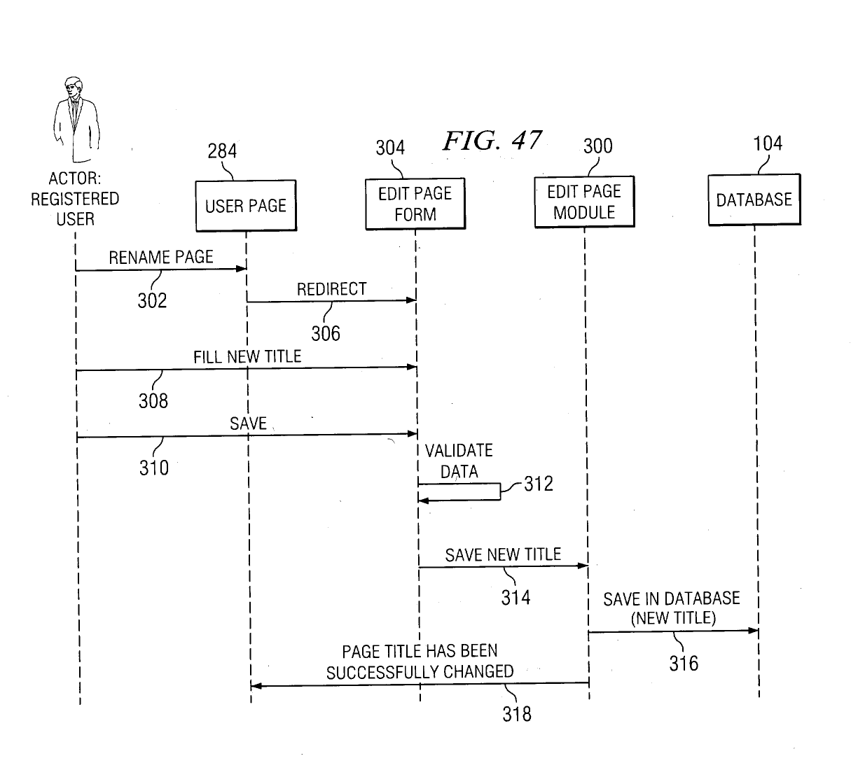

FIG. 47 is a sequence diagram for adding pages. When adding a page 213, the user is first prompted for a title 220. If the title is not validated 222 as being between two and twenty characters and only containing valid characters, the user is prompted with an error message and a request to re-enter a page title name. Once a valid name has been entered, the page limit is verified 228. If the page limit is exceeded, the user is told that they cannot create a new page since they have reached the limit. If the limit has not been exceeded, a blank page is created in the database and presented in the user's user interface along with a message indicating a successful page addition. FIG. 48 shows a screen prompting for the new page title.

The user can also switch to an existing page 214. FIG. 38 presents the sequence diagram for this operation. The user selects the tab for a page and the UserForm module 3800 requests the page by PageID at 244 from the ViewPageModule 242. The ViewPageModule 242 resides on the server 100. The ViewPageModule 242 retrieves the page from the database 104 and retrieves all the portlets against that particular PageID. The whole contents are then passed back to the user at 258 for display in the user interface.

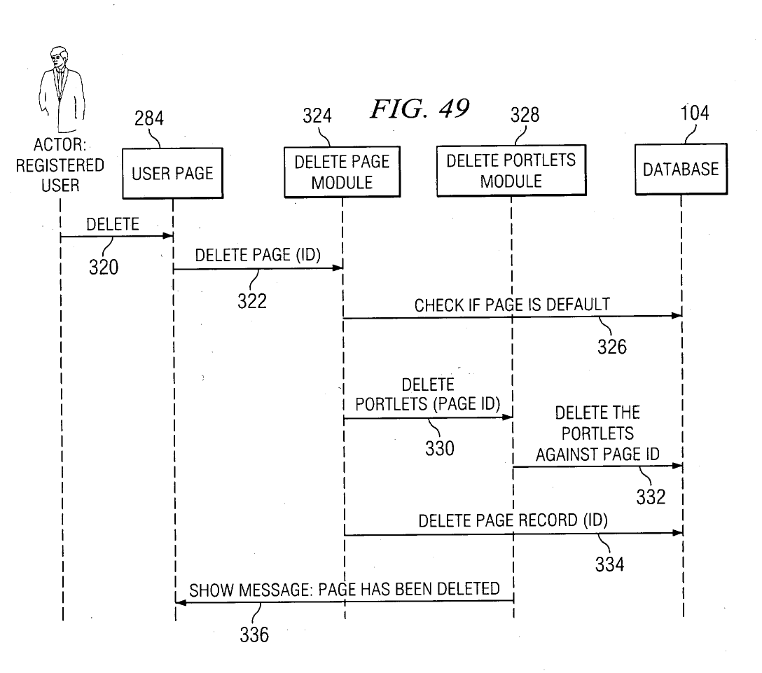

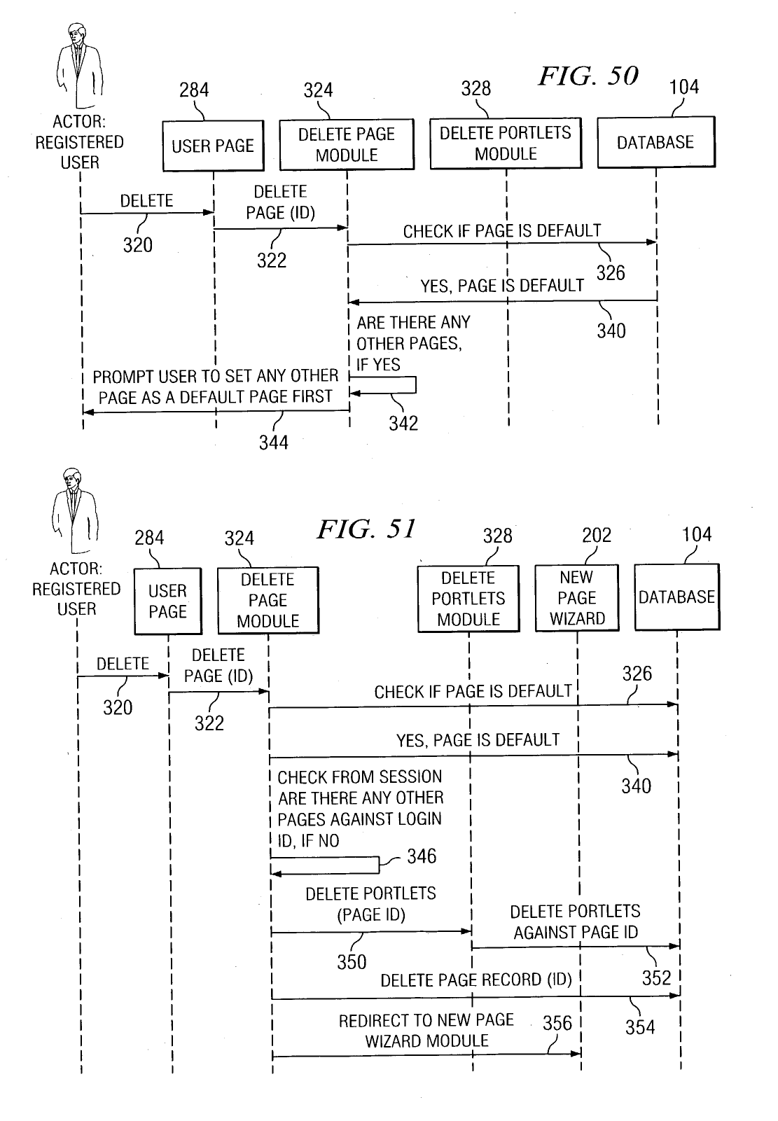

FIG. 49 presents the Sequence Diagram for renaming a page. When a user wishes to rename a page, they select (302) the button for doing so, which in turn brings up the EditPageForm 304 in their interface. The EditPageForm 304 in this case has a single entry field for a new page name, and is seen in FIG. 50. The user enters the new page name at 308 and hits OK (310), triggering the new page title to be validated at 312 by the EditPageForm 304 and then sent back to the EditPageModule 300 on the server. The EditPageModule stores 316 the new name in the database 104 and returns a message to the user that the page title has been successfully modified at 318.

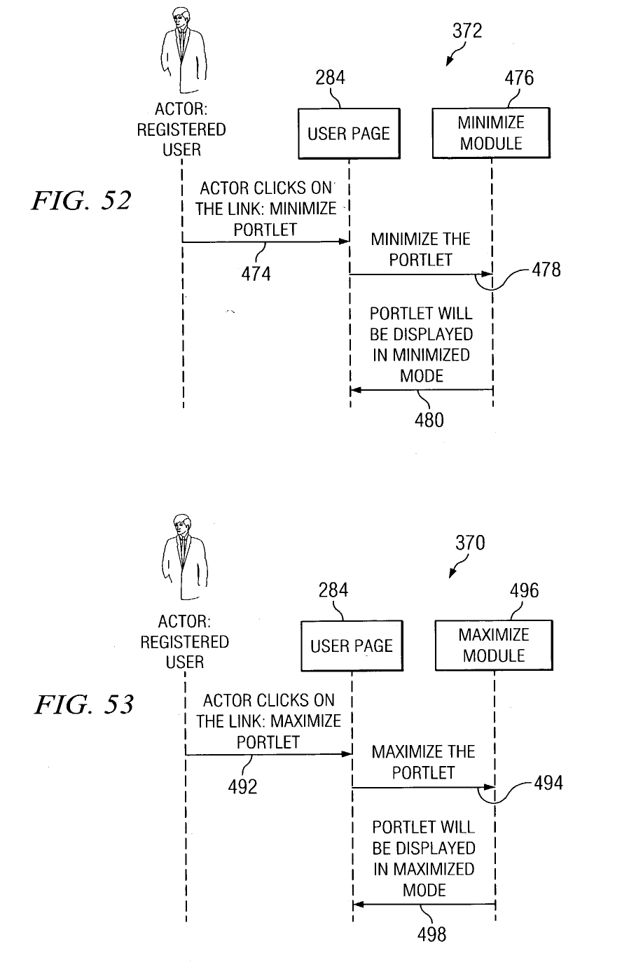

FIG. 51 presents the sequence diagram for deleting a page. A user can choose to delete a page 320 by selecting the delete page button at the top of the screen; see 3108 in FIG. 31, for example. The UserPage module 284 sends the page id along with a delete request at 322 to the DeletePageModule 324 on the server. The DeletePageModule passes, at 330, the PageID to the Deleteportlets Module 328 which in turn deletes at 332 all portlets that are associated with that particular PageID. Once that's complete, the DeletePageModule 324 deletes, at 334, the page with PageID from the database 104 and returns a message to the user that the page has been deleted 336. By convention, the display shows the default page after a page deletion. FIGS. 52 and 53 show other possible sequences upon activation of the “delete page” function.

Other Portlet Operations

In addition to performing operations on a page, the user can perform operations on a portlet. FIG. 9 (top) shows a use case for the various operations a user can perform on a portlet. Users can add portlets 384, minimize them 372, restore them 370, delete them (individually) 374, rearrange them on a page 376, edit or recreate them 378, rename them 380 and manually refresh them 382.

Minimizing and Restoring a Portlet (372)

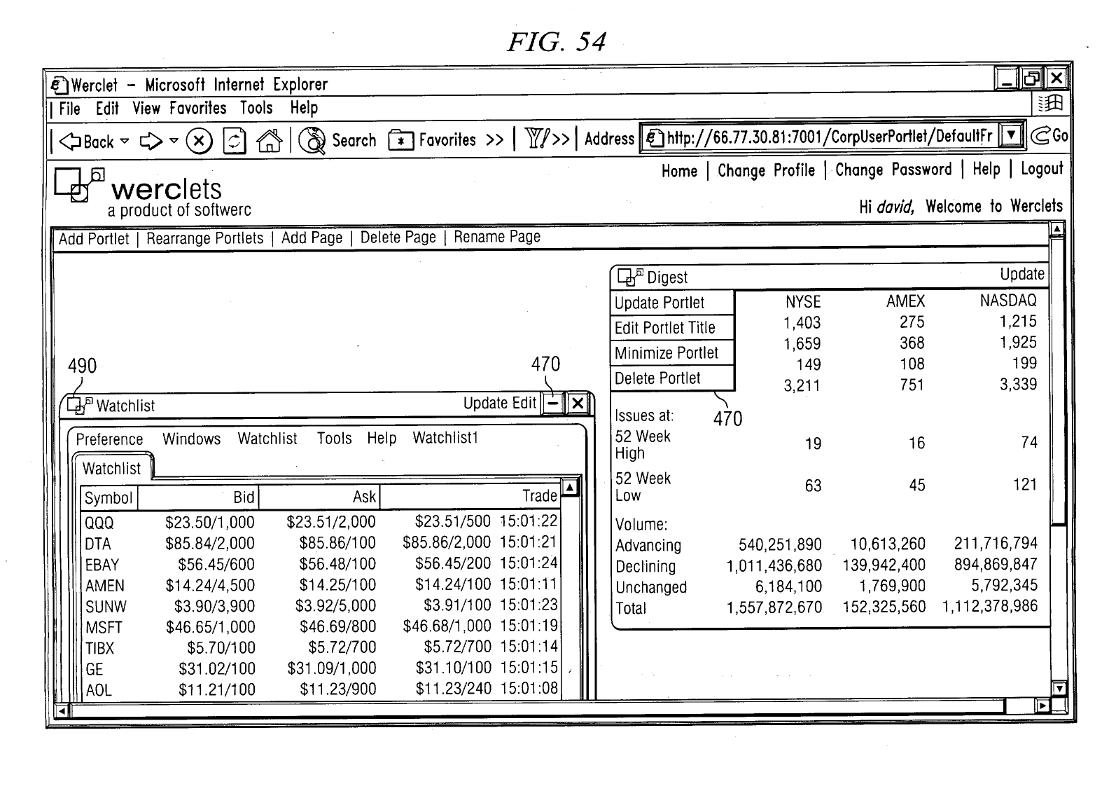

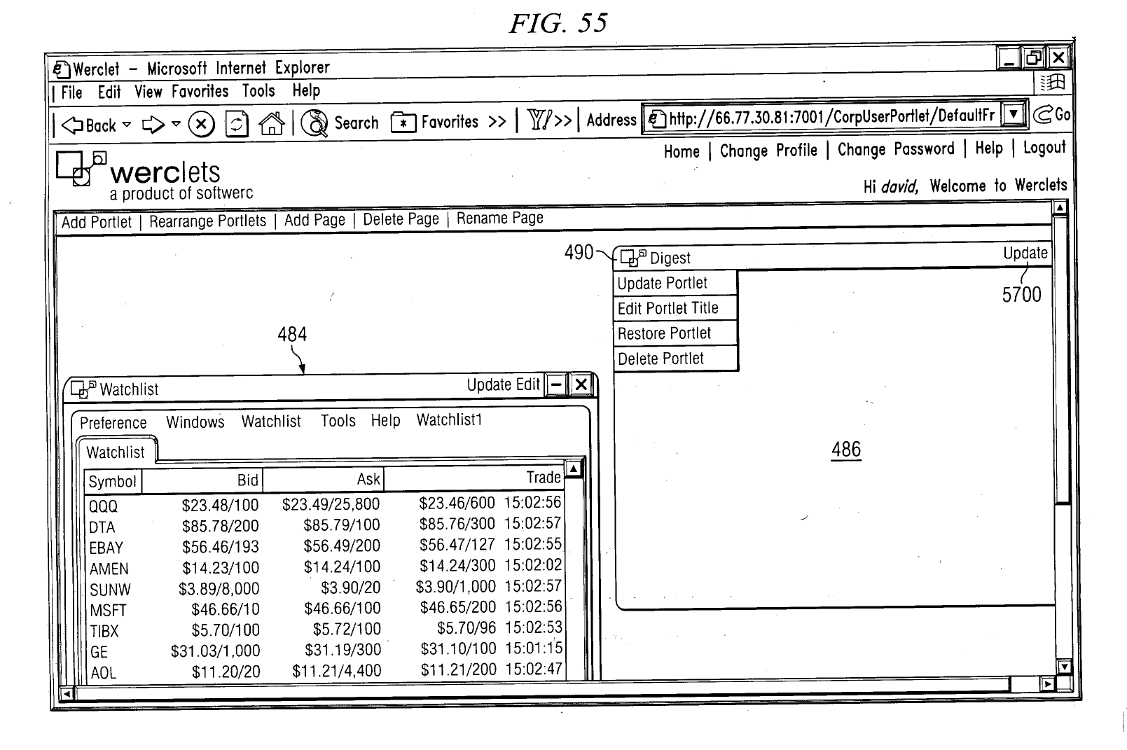

Above, we mentioned how portlets are built using two DIV tags and embedding an IFRAME in them. These two DIV tags are setup in a parent-child relationship, where the parent tag contains two major portions, the header of the portlet, which is displayed using table tag, and the body of the portlet, which holds the actual portlet contents. In order to minimize a portlet (action 474 in FIG. 54), we simply change the height of the parent DIV tag, eliminating (480) the space where the child can be displayed. To restore or maximize the display (see FIG. 55 for the user sequence diagram), we change the height of the parent again, increasing it to the original height and displaying the portlet contents.

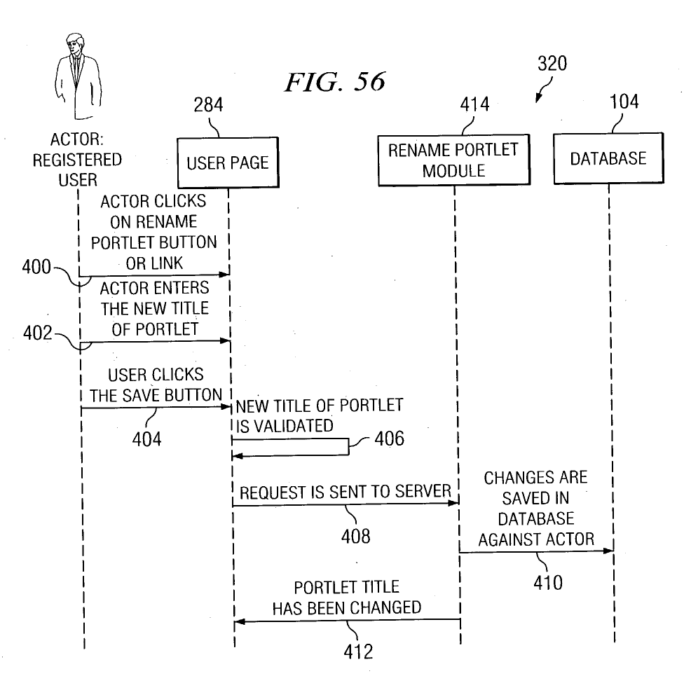

FIG. 56 is a representation of the user interface. To minimize a portlet the user can click the minimize button 470 at the top right corner of the pane or select the logo 490 in the top left corner of the pane which in turn causes a pull down menu to drop down. The user can then select “minimize portlet.”

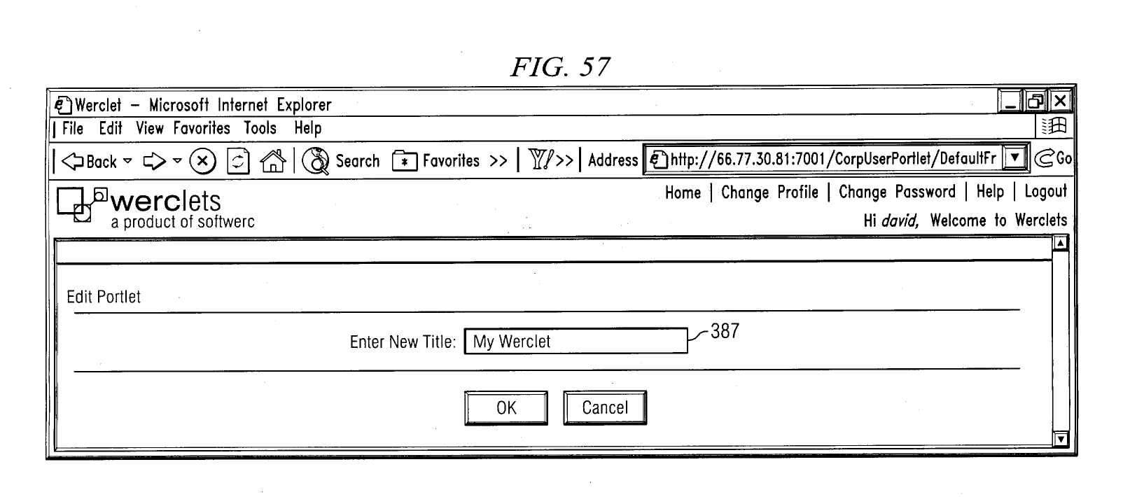

FIG. 55 presents the sequence diagram for restoring portlets. The user selects, 492, the restore button (5700 in FIG. 57) which causes the UserPage module 284 to request that the MaximizeModule 496 restore the portlet to its original size. FIG. 57 is a screen capture of the user interface as implemented. The user can select button 5700 in the top right or click on logo 490 to get the pull down menu and select restore.

Renaming a Portlet (FIG. 9, 380)

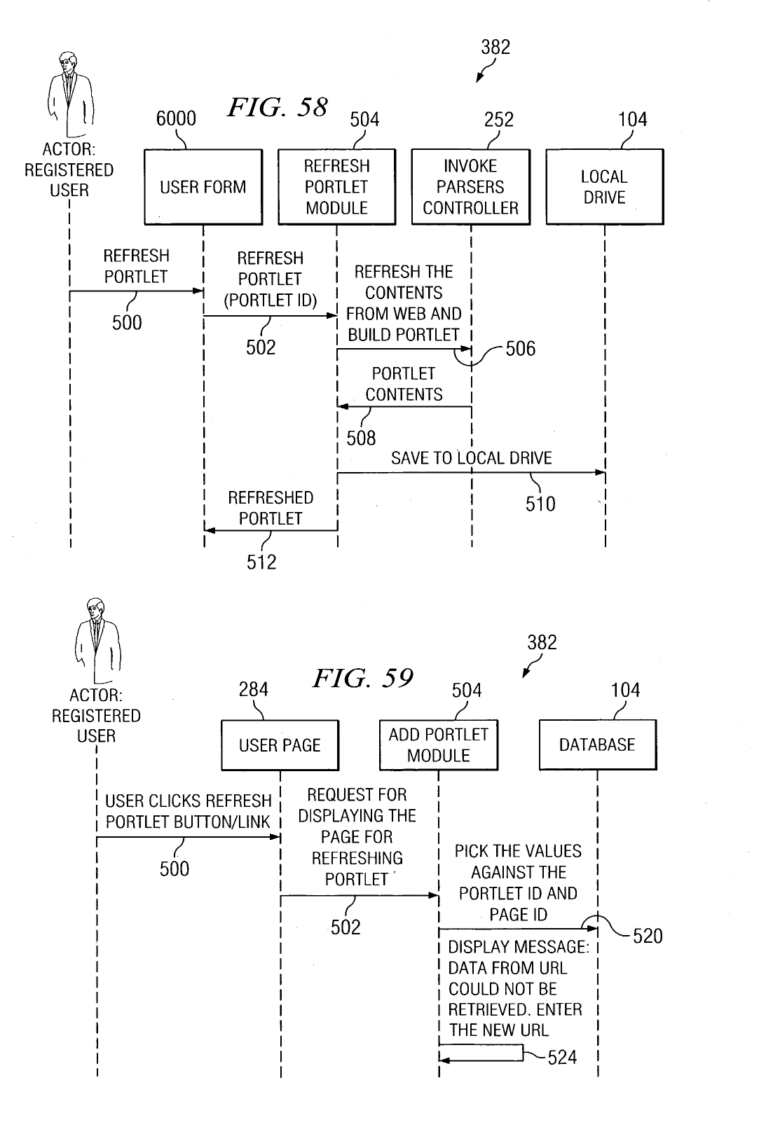

Renaming portlets 380 is demonstrated in the sequence diagram in FIG. 58. User choose to rename the portlet 400 which causes the UserPage module 284 to present a field for a new name. This is shown in FIG. 59. When the user clicks the save button 404 the UserPage module validates the new title as it must not contain unusual characters and must be between 2 and 20 characters long. If it's valid, the request is sent, 408, to the server where the Renameportlet Module 414 saves the changes to the database 104, and passes a confirmation, 412, back to the user. If the name isn't valid, the user is presented with the opportunity to try again, with a message indicating why the original name wasn't valid.

Refreshing a portlet (FIG. 9, 382) is similar to the feature described above of individual portlet refreshing within a single page, which is unique to our invention. However, refreshing a portlet manually is different in that it doesn't depend upon the predefined schedule, but allows the user to refresh a portlet ad-hoc by clicking a button on the interface. This process is defined in sequence diagram of FIG. 60. When the user initiates this process 500, a UserForm 6000 sends a request 502 to refresh a portlet and specifies a wercletID. Clicking on the refresh button kicks off the process of having the JavaScript code in the portlet request from the parsing controller that the portlet get updated. The Refreshportlet Module 504 receives the request and the ID number and passes it to the ParserController 252, which refreshes the portlet from its original source. The updated portlet is passed back at 508 to the Refreshportlet Module 504 which updates the local database 104 and passes the refreshed portlet back to the UserForm for display in the user interface. FIG. 61 shows the sequence diagram defining what occurs if the portlet is unable to be retrieved upon refresh.

While the present invention has been described in conjunction with the illustrated embodiments, the invention is not limited thereto but only by the scope and spirit of the appended claims.

We claim:

1. A method for populating a user interface with a web-enabled object from a page of the World Wide Web, comprising the steps of:
designating, by a user, a web enabled object present on a web page;
parsing the page to define a plurality of nested tables, a largest of the nested tables consisting of the entire web page, the smallest of the nested tables corresponding to the smallest parsable object which the user has designated;
presenting, to the user, visual representations of each of the nested tables;
accepting a selection by the user of one of the nested tables; and
retrieving the accepted table for population of the user interface.

2. The method of claim 1, wherein said step of designating is accomplished by the user pointing to an object on a web page with a mouse and clicking on the object.

3. The method of claim 1, wherein the nested tables include at least one intermediate table between the largest table and the smallest table.

4. A method for populating a user interface of a thin client with a web enabled object, comprising the steps of: storing, a web-enabled object in a memory;
retrieving the web enabled object from the memory to a user interface stored on a host server, the host server being in communication with a thin client controlled by the user and being coupled to the memory,
designating, by the user, an initial location of the web-enabled object on the user interface;
responsive to the step of designating, placing an image of the web-enabled object at the initial location of the user interface;
designating, by the user, a second location of the web-enabled object on the user interface; and
responsive to the last said step of designating, moving the image of the web-enabled object to the second location.

5. The method of claim 4, wherein said steps of designating are accomplished by pointing to the locations on the user interface with a mouse and clicking on the locations.

6. The method of claim 4, and further comprising the steps of: [upper left hand corner]

7. A method of parsing a complex web-enabled object, comprising the steps of:
reading a web-enabled object containing statements written in a markup language and statements in a second web-enabled language different from the markup language;
for each statement in the second language, performing the following steps:
executing the statement to obtain a resulting expression in the markup language;
substituting the resulting expression in the markup language for the statement in the second language in a modified image of the web-enabled object; and
parsing the modified image into a plurality of components for selection by a user.

8. The method of claim 7, and further comprising the steps of:
accepting a selection by the user of one of the plurality of components; and
storing the selected component of the web-enabled object as including at least one statement in the second language.

9. The method of claim 7, wherein the markup language is selected from the group consisting of HTML, DHTML and XML.

10. The method of claim 7, wherein the second language is selected from the group consisting of JavaScript, DHTML, XML and flash.

11. The method of claim 7, and further including the step of:
performing said steps of reading, executing, substituting and parsing on a server in communication with a thin client operated by the user.

12. A method of assembling a portal containing a plurality of web-enabled objects, comprising the steps of:
identifying a web-enabled object within a source having an address on the world wide web;
parsing first statements in a first web-enabled language in the object into a plurality of tables;
during said step of parsing, encountering at least one second statement in a second web-enabled language different from the first web-enabled language;
substituting a substitute statement in the first web-enabled language for the at least one second statement;
performing said steps of parsing, encountering and substituting until the object is parsed;
selecting by the user one of the parsed tables to define a web-enabled object to be stored;
copying the selected web-enabled object as including statements in the first and second languages to a storing location;
assigning a URL to the stored web-enabled object; and
retrieving the web-enabled object to a portal creation application by using the URL assigned to the stored web-enabled object.
